(19) United States
(12) Patent Application Publication
(10) Pub. No.: US 2022/0221689 A1
(43) Pub. Date: Jul. 14, 2022

(54) Optical Imaging Lens Assembly

(71) Applicant: ZHEJIANG SUNNY OPTICS CO.,LTD., Ningbo (CN)

(72) Inventors: Chen CHEN, Ningbo (CN); Xiaoxiao ZHU, Ningbo (CN); Wuchao XU, Ningbo (CN); Fujian DAI, Ningbo (CN); Liefeng ZHAO, Ningbo (CN)

(21) Appl. No.: 17/570,393

(22) Filed: Jan. 7, 2022

(30) Foreign Application Priority Data
Jan. 7, 2021 (CN) 202110017713.9

(51) Int. Cl. G02B 9/64; G02B 13/00

(52) U.S. Cl. CPC G02B 9/64; G02B 13/0045

(57) ABSTRACT

The disclosure provides an optical imaging lens assembly, which sequentially includes, from an object side to an image side along an optical axis: a first lens with a positive refractive power; a second lens with a refractive power; a third lens with a refractive power; a fourth lens with a positive refractive power; a fifth lens with a refractive power, an object-side surface thereof being a convex surface while an image-side surface being a concave surface; a sixth lens with a positive refractive power, an object-side surface thereof being a convex surface while an image-side surface being a convex surface; and a seventh lens with a negative refractive power. ImgH is a half of a diagonal length of an effective pixel region on an imaging surface, TTL is an on-axis distance from an object-side surface of the first lens to the imaging surface, ImgH and TTL satisfy: 4.0 mm<ImgH×ImgH/TTL<6.0 mm.

### CROSS-REFERENCE TO RELATED APPLICATION(S)

The disclosure claims priority to and the benefit of Chinese Patent Application No. 202110017713.9, filed in the China National Intellectual Property Administration (CNIPA) on 7 Jan. 2021, which is incorporated herein by reference in its entirety.

### TECHNICAL FIELD

The disclosure belongs to the field of optical imaging, and relates to an optical imaging lens assembly including seven lenses.

### BACKGROUND

With the performance improvement of photosensitive elements and the size reduction of image elements, higher requirements have been made to corresponding optical imaging lens assemblies, and thus lens assemblies with large apertures, high resolutions, small sizes and the like have emerged. An imaging system is required to image a scene clearly.

In order to meet an application requirement of a main camera in a next-generation high-end smart phone better, an optical imaging system with a large image surface, and a large aperture is needed.

### SUMMARY

The disclosure is intended to provide an optical imaging lens assembly including seven lenses, which has the optical performance of large image surface, large aperture, etc.

An embodiment of the disclosure provides an optical imaging lens assembly, which sequentially includes, from an object side to an image side along an optical axis: a first lens with a positive refractive power; a second lens with a refractive power; a third lens with a refractive power; a fourth lens with a positive refractive power; a fifth lens with a refractive power, an object-side surface thereof being a convex surface while an image-side surface being a concave surface; a sixth lens with a positive refractive power, an object-side surface thereof being a convex surface while an image-side surface being a convex surface: and a seventh lens with a negative refractive power.

ImgH is a half of a diagonal length of an effective pixel region on an imaging surface, TTL is an on-axis distance from an object-side surface of the first lens to the imaging surface, and ImgH and TTL satisfy: 4.0 mm<ImgH×ImgH/TTL<6.0 mm. FOV is a maximum field of view of the optical imaging lens assembly, and an effective focal length f of the optical imaging lens assembly and FOV satisfy: 4.8 mm<f×tan(1/2FOV)<5.8 mm.

In an implementation mode, TTL and ImgH satisfy: TTL/ImgH<1.3.

In an implementation mode, EPD is an entrance pupil diameter of the optical imaging lens assembly, and the effective focal length f of the optical imaging lens assembly and EPD satisfy: f/EPD<1.7.

In an implementation mode, a curvature radius R11 of the object-side surface of the sixth lens, a curvature radius R12 of the image-side surface of the sixth lens and an effective focal length f6 of the sixth lens satisfy: 2.0<(R11-R12)/f6<2.5.

In an implementation mode, an effective focal length f1 of the first lens, an effective focal length f7 of the seventh lens and the effective focal length f of the optical imaging lens assembly satisfy: 1.4<(f1-f7)/f<1.8.

In an implementation mode, an effective focal length f2 of the second lens, a curvature radius R4 of an image-side surface of the second lens and a curvature radius R3 of an object-side surface of the second lens satisfy: 1.9<f2/(R4-R3)<7.1.

In an implementation mode, a center thickness CT1 of the first lens on the optical axis, a center thickness CT2 of the second lens on the optical axis, a center thickness CT3 of the third lens on the optical axis and a center thickness CT4 of the fourth lens on the optical axis satisfy: 1.4<(CT1+CT2)/(CT3+CT4)<2.2.

In an implementation mode, a combined focal length f12 of the first lens and the second lens, a combined focal length f67 of the sixth lens and the seventh lens and a combined focal length f34 of the third lens and the fourth lens satisfy: −1.0<(f12-f67)/f34<1.0.

In an implementation mode, SAG62 is an on-axis distance from an intersection point of the image-side surface of the sixth lens and the optical axis to an effective radius vertex of the image-side surface of the sixth lens, SAG52 is an on-axis distance from an intersection point of the image-side surface of the fifth lens and the optical axis to an effective radius vertex of the image-side surface of the fifth lens satisfy: 1.6<SAG62/SAG52<2.4.

In an implementation mode, SAG71 is an on-axis distance from an intersection point of an object-side surface of the seventh lens and the optical axis to an effective radius vertex of the object-side surface of the seventh lens, and SAG71 and an edge thickness ET7 of the seventh lens satisfy: −3.6<SAG71/ET7<−1.3.

In an implementation mode, an edge thickness ET4 of the fourth lens, an edge thickness ET5 of the fifth tens and an edge thickness ET6 of the sixth lens satisfy conditional expression: 0.7<(ET4+ET5)/ET6<1.4.

Another aspect of the disclosure provides an optical imaging lens assembly, which sequentially includes, from an object side to an image side along an optical axis: a first lens with a positive refractive power; a second lens with a refractive power; a third lens with a refractive power; a fourth lens with a positive refractive power; a fifth lens with a refractive power, an object-side surface thereof being a convex surface while an image-side surface being a concave surface; a sixth lens with a positive refractive power, an object-side surface thereof being a convex surface while an image-side surface being a convex surface; and a seventh lens with a negative refractive power.

The lenses are independent of one another. There is an air space between each lens on the optical axis. ImgH is a half of a diagonal length of an effective pixel region on an imaging surface, TTL is an on-axis distance from an object-side surface of the first lens to the imaging surface, and ImgH and TTL satisfy: 4.0 mm<ImgH×ImgH/TTL<6.0 mm, EPD is an entrance pupil diameter of the optical imaging lens assembly, and an effective focal length f of the optical imaging lens assembly and EPD satisfy: f/EPD<1.7.

The disclosure has the following beneficial effects.

The optical imaging lens assembly provided in the disclosure includes multiple lenses, e.g., the first lens to the seventh lens. The configuration of the refractive power of each component of the system is controlled reasonably, so that a low-order aberration of the system may be balanced effectively, and the tolerance sensitivity may be reduced. A proportional relationship between the total optical length of the system and a half of an image height is restricted, thereby achieving the characteristics of large image surface and ultra-thin design of the optical system and endowing the optical system with a good imaging effect.

### BRIEF DESCRIPTION OF THE DRAWINGS

In order to describe the technical solutions in the embodiments of the disclosure more clearly, the drawings required to be used for describing the embodiments will be simply introduced below. It is apparent that the drawings described below are only some embodiments of the disclosure. Those of ordinary skill in the art may further obtain other drawings according to these drawings without creative work.

FIG. 1 shows a structure diagram of a lens group of an optical imaging lens assembly according to Embodiment 1 of the disclosure;

FIGS. 2a-2d show a longitudinal aberration curve, an astigmatism curve, a distortion curve and a lateral color curve of an optical imaging lens assembly according to Embodiment 1 of the disclosure respectively;

FIG. 3 shows a structure diagram of a lens group of an optical imaging lens assembly according to Embodiment 2 of the disclosure;

FIGS. 4a-4d show a longitudinal aberration curve, an astigmatism curve, a distortion curve and a lateral color curve of an optical imaging lens assembly according to Embodiment 2 of the disclosure respectively;

FIG. 5 shows a structure diagram of a lens group of an optical imaging lens assembly according to Embodiment 3 of the disclosure;

FIGS. 6a-6d show a longitudinal aberration curve, an astigmatism curve, a distortion curve and a lateral color curve of an optical imaging lens assembly according to Embodiment 3 of the disclosure respectively;

FIG. 7 shows a structure diagram of a lens group of an optical imaging lens assembly according to Embodiment 4 of the disclosure;

FIGS. 8a-8d show a longitudinal aberration curve, an astigmatism curve, a distortion curve and a lateral color curve of an optical imaging lens assembly according to Embodiment 4 of the disclosure respectively;

FIG. 9 shows a structure diagram of a lens group of an optical imaging lens assembly according to Embodiment 5 of the disclosure;

FIGS. 10a-10d show a longitudinal aberration curve, an astigmatism curve, a distortion curve and a lateral color curve of an optical imaging lens assembly according to Embodiment 5 of the disclosure respectively;

FIG. 11 shows a structure diagram of a lens group of an optical imaging lens assembly according to Embodiment 6 of the disclosure;

FIGS. 12a-12d show a longitudinal aberration curve, an astigmatism curve, a distortion curve and a lateral color curve of an optical imaging lens assembly according to Embodiment 6 of the disclosure respectively;

FIG. 13 shows a structure diagram of a lens group of an optical imaging lens assembly according to Embodiment 7 of the disclosure;

FIGS. 14a-14d show a longitudinal aberration curve, an astigmatism curve, a distortion curve and a lateral color curve of an optical imaging lens assembly according to Embodiment 7 of the disclosure respectively;

FIG. 15 shows a structure diagram of a lens group of an optical imaging lens assembly according to Embodiment 8 of the disclosure; and

FIGS. 16a-16d show a longitudinal aberration curve, an astigmatism curve, a distortion curve and a lateral color curve of an optical imaging lens assembly according to Embodiment 8 of the disclosure respectively.

### DETAILED DESCRIPTION OF THE EMBODIMENTS

The technical solutions in embodiments of the disclosure will be clearly and completely described below in combination with the drawings in the embodiments of the disclosure. It is apparent that the described embodiments are not all but only part of embodiments of the disclosure. All other embodiments obtained by those of ordinary skill in the art based on the embodiments in the disclosure without creative work shall fall within the scope of protection of the disclosure.

It should be noted that, in this description, the expressions of first, second, third and the like are only used to distinguish one feature from another feature and do not represent any limitation to the feature. Thus, a first lens discussed below may also be referred to as a second lens or a third lens without departing from the teachings of the disclosure.

It should also be understood that terms “include”, “including”, “have”, “contain”, and/or “containing”, used in the specification, represent existence of a stated feature, component and/or part but do not exclude existence or addition of one or more other features, components and parts and/or combinations thereof. In addition expressions like “at least one in . . . ” may appear after a list of listed features not to modify an individual component in the list but to modify the listed features.

Moreover, when the implementation modes of the disclosure are described, “may” is used to represent “one or more implementation modes of the disclosure”. Furthermore, term “exemplary” refers to an example or exemplary description.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings. The drawings are by way of example only and not strictly to scale.

In the description of the disclosure, a paraxial region refers to a region nearby an optical axis, if a surface of a lens is a convex surface and a position of the convex surface is not defined, it indicates that at least a paraxial region of the surface of the lens is a convex surface. If a surface of a lens is a concave surface and a position of the concave surface is not defined, it indicates that at least a paraxial region of the surface of the lens is a concave surface. A surface, closest to a shot object, of each lens is called an object-side surface of the lens, and a surface, closest to an imaging surface, of each lens is called an image-side surface of the lens.

Unless otherwise defined, all terms (including technical terms and scientific terms) used in the disclosure have the same meanings as commonly understood by those of ordinary skill in the art of the disclosure. It should also be understood that the terms (for example, terms defined in a common dictionary) should be explained to have meanings consistent with the meanings in the context of a related art and may not be explained with ideal or excessively formal meanings, unless clearly defined like this in the disclosure.

It is to be noted that the embodiments in the disclosure and features in the embodiments may be combined without conflicts. The features, principles and other aspects of the disclosure will be described in detail below with reference to the drawings and in combination with embodiments.

Exemplary Implementation Mode

An optical imaging lens assembly of the exemplary implementation mode of the disclosure include seven lenses, sequentially including, from an object side to an image side, a first lens, a second lens, a third lens, a fourth lens, a fifth lens, a sixth lens, and a seventh lens. The lenses are independent of one another. There is an air space between each lens on the optical axis.

In an exemplary embodiment, the first lens has a positive refractive power. The second lens may have a positive refractive power or a negative refractive power. The third lens may have a positive refractive power or a negative refractive power. The fourth lens has a positive refractive power. The fifth lens may have a positive refractive power or a negative refractive power, and an object-side surface thereof is a convex surface while an image-side surface is a concave surface. The sixth lens has a positive refractive power, and an object-side surface thereof is a convex surface while an image-side surface is a convex surface. The seventh lens has a negative refractive power. The configuration of the refractive power of each component of the system is controlled reasonably, so that a low-order aberration of the system may be balanced effectively, and the tolerance sensitivity may be reduced.

In an exemplary embodiment, ImgH is a half of a diagonal length of an effective pixel region on an imaging surface, TTL is an on-axis distance from an object-side surface of the first lens to the imaging surface, and ImgH and TTL satisfy conditional expression; 4.0 mm<ImgH×ImgH/TTL<6.0 mm. A proportional relationship between the total optical length of the system and a half of an image height is restricted, thereby achieving the characteristics of large image surface and ultra-thin design of the optical system and endowing the system with a good imaging effect. More specifically, ImgH and TTL satisfy: 4.09 mm≤ImgH×ImgH/TTL≤4.12 mm.

In an exemplary embodiment, TTL is an on-axis distance from an object-side surface of the first lens to an imaging surface, ImgH is a half of a diagonal length of an effective pixel region on the imaging surface, and TTL and ImgH satisfy conditional expression: TTL/ImgH<1.3. A ratio of the total optical length of the system to a half of an image height is restricted in a certain range to achieve the characteristics of ultra-thin design and high resolution of the optical imaging system. More specifically, TTL and ImgH satisfy: 1.26≤TTL/ImgH≤1.27.

In an exemplary embodiment, FOV is a maximum field of view of the optical imaging lens assembly, and an effective focal length f of the optical imaging lens assembly and FOV satisfy conditional expression: 4.8 mm<f×tan(1/2FOV)<5.8 mm, A relationship between an effective focal length and a field of view is restricted to control the size of the image surface of the optical system. More specifically, f and FOV satisfy: 4.97 mm≤f×tan(1/2FOV)≤5.01 mm.

In an exemplary embodiment, EPD is an entrance pupil diameter of the optical imaging lens assembly, and an effective focal length f of the optical imaging lens assembly and EPD satisfy conditional expression: f/EPD<1.7. A ratio of the effective focal length to the entrance pupil diameter is restricted to further control the aperture of the optical system to achieve the characteristic of large aperture. More specifically, f and EPD satisfy: f/EPD=1.65.

In an exemplary embodiment, a curvature radius R11 of the object-side surface of the sixth lens, a curvature radius R12 of the image-side surface of the sixth lens and an effective focal length f6 of the sixth lens satisfy conditional expression: 2.0<(R11-R12)/f6<2.5. A ratio of the curvature radii of the object-side surface and the image-side surface of the sixth lens to the effective focal length is controlled, so that a deflection angle of a marginal ray of the system may be controlled reasonably, high machinability of the optical lens assembly is ensured, and the sensitivity of the system is reduced. More specifically, R11, R12 and f6 satisfy: 2.10≤(R11-R12)/f6≤2.32.

In an exemplary embodiment, an effective focal length f1 of the first lens, an effective focal length f7 of the seventh lens and the effective focal length f of the optical imaging lens assembly satisfy conditional expression: 1.4<(f1-f7)/f<1.8. The effective focal lengths of the first lens and the seventh lens are controlled, so that contributions of the first and seventh lenses to an aberration of the whole optical system may be controlled, and an off-axis aberration of the system may be balanced to further improve the imaging quality of the system. More specifically, f1, f7 and f satisfy: 1.52≤(f1-47)/f≤1.61.

In an exemplary embodiment, an effective focal length f2 of the second lens, a curvature radius R4 of an image-side surface of the second lens and a curvature radius R3 of an object-side surface of the second tens satisfy conditional expression: 1.9<f2/(R4-R3)<7.1. A ratio of the effective focal length of the second lens and the curvature radii of the object-side surface and the image-side surface is controlled in a reasonable range to reduce the sensitivity of a front-end lens, ensure the machinability and simultaneously improve the yield. More specifically, f2, R4 and R3 satisfy: 1.93≤f2/(R4-R3)≤6.98.

In an exemplary embodiment, a center thickness CT1 of the first lens on the optical axis, a center thickness CT2 of the second lens on the optical axis, a center thickness CT3 of the third lens on the optical axis and a center thickness CT4 of the fourth lens on the optical axis satisfy conditional expression: 1.4<(CT1+CT2)/(CT3+CT4)<2.2. The center thicknesses of the first four lenses are restricted to control field curvature contributions in each field of view of the system in a reasonable range to balance field curvatures generated by the other lenses, and effectively improve the resolving power of the lens assembly. More specifically, CT1, CT2, CT3 and CT4 satisfy: 1.58≤(CT1+CT2)/(CT3+CT4)≤2.07.

In an exemplary embodiment, a combined focal length f12 of the first lens and the second lens, a combined focal length f67 of the sixth lens and the seventh lens and a combined focal length f34 of the third lens and the fourth tens satisfy conditional expression: −1.0<(f12-f67)/f34<1.0. A relationship between the focal lengths of the lenses is restricted to configure the refractive power of the optical system reasonably, and achieve the characteristics of high imaging quality, low sensitivity and ease of machining and forming. More specifically, f12, f67 and f34 satisfy: −0.65≤(f12-f67)/f34≤0.49.

In an exemplary embodiment, SAG62 is an on-axis distance from an intersection point of the image-side surface of the sixth lens and the optical axis to an effective radius vertex of the image-side surface of the sixth lens, SAG52 is an on-axis distance from an intersection point of the image-side surface of the fifth lens and the optical axis to an effective radius vertex of the image-side surface of the fifth lens satisfy conditional expression: 1.6<SAG62/SAG52<2.4. A vector height ratio of the sixth lens and the fifth lens is controlled to restrict the uniformity of a shape transition of the lenses reasonably, simultaneously reduce the off-centering and tilt sensitivity of the fifth lens and the sixth lens, achieve relatively great benefits for the distortion of the optical system and facilitate batch production. More specifically, SAG62 and SAG52 satisfy: 1.80≤SAG62/SAG52≤2.26.

In an exemplary embodiment, SAG71 is an on-axis distance from an intersection point of an object-side surface of the seventh lens and the optical axis to an effective radius vertex of the object-side surface of the seventh lens, and SAG71 and an edge thickness ET7 of the seventh lens satisfy conditional expression: −3.6<SAG71/ET7<−1.3. A ratio of the vector height to edge thickness of the seventh lens is controlled, so that difficulties in the forming, coating and assembling of the lens are reduced, the risk in the formation of weld lines is also avoided, and the assembling yield is improved. More specifically, SAG71 and ET7 satisfy: −3.55≤SAG71/ET7≤−1.38.

In an exemplary embodiment, an edge thickness ET4 of the fourth lens, an edge thickness ET5 of the fifth tens and an edge thickness ET6 of the sixth lens satisfy conditional expression; 0.7<(ET4+ET5)/ET6<1.4. The edge thicknesses of the fourth lens, the fifth lens and the sixth lens are restricted to control the reasonability of shapes of the lenses, balance the field curvature of the system and improve the aberration correction capability of the system. More specifically, ET4, ET5 and ET6 satisfy: 0.82≤(ET4+ET5)/ET6≤1.19.

In an exemplary embodiment, the optical imaging lens assembly may further include a diaphragm. The diaphragm may be arranged at an appropriate position as required. For example, the diaphragm may be arranged between the object side and the first lens. Optionally, the optical imaging lens assembly may further include an optical filter configured to correct the chromatic aberration and/or protective glass configured to protect a photosensitive element on the imaging surface.

The optical imaging lens assembly according to the exemplary embodiment of the disclosure may adopt multiple lenses, for example, the above-mentioned seven lenses. The refractive power and surface types of each lens, the center thickness of each lens, on-axis distances between the lenses and the like are configured reasonably to endow the optical imaging lens assembly with a relatively large imaging surface and the characteristics of wide imaging range and high imaging quality, and ensure an ultra-thin design of a mobile phone.

In an exemplary embodiment, at least one of mirror surfaces of each lens is an aspheric mirror surface. That is, at least one mirror surface in the object-side surface of the first lens to the image-side surface of the seventh lens is an aspheric mirror surface. An aspheric lens has such a characteristic that a curvature keeps changing from a center of the lens to a periphery of the lens. Unlike a spherical lens with a constant curvature from a center of the lens to a periphery of the lens, the aspheric lens has a better curvature radius characteristic and the advantages of improving distortions and improving astigmatic aberrations. With the adoption of the aspheric lens, astigmatic aberrations during imaging may be eliminated as much as possible, thereby improving the imaging quality. Optionally, at least one of the object-side surface and image-side surface of each lens in the first lens, the second lens, the third lens, the fourth lens, the fifth lens, the sixth lens and the seventh lens is an aspheric mirror surface. Optionally, both the object-side surface and image-side surface of each lens in the first lens, the second lens, the third lens, the fourth lens, the fifth lens, the sixth lens and the seventh lens are aspheric mirror surfaces.

However, those skilled in the art should know that the number of the lenses forming the optical imaging lens assembly may be changed without departing from the technical solutions claimed in the disclosure to achieve each result and advantage described in the specification. For example, although descriptions are made in the exemplary embodiment with seven lenses as an example, the optical imaging lens assembly is not limited to seven lenses. If necessary, the optical imaging lens assembly may also include another number of lenses. Specific embodiments applicable to the optical imaging lens assembly of the above-mentioned embodiment will further be described below with reference to the drawings.

### Embodiment 1

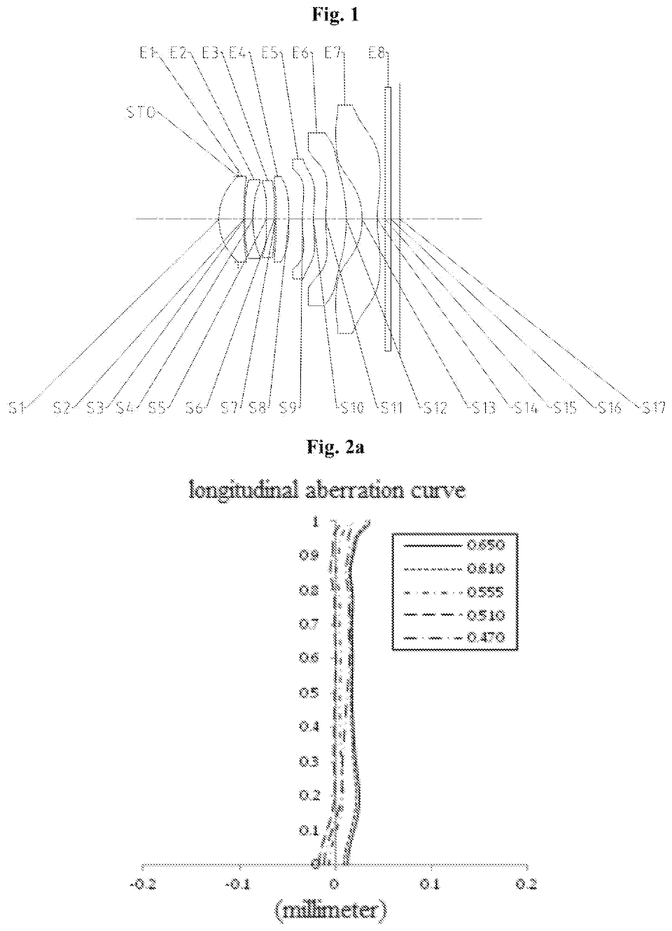

FIG. 1 is a structure diagram of a lens group of an optical imaging lens assembly according to Embodiment 1 of the disclosure. The optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a negative refractive power, an object-side surface S5 thereof is a concave surface, while an image-side surface S6 is a concave surface. The fourth lens E4 has a positive refractive power, an object-side surface S7 thereof is a convex surface. while an image-side surface S8 is a convex surface. The fifth lens E5 has a positive refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

Table 1 shows a table of basic parameters for the optical imaging lens assembly of Embodiment 1, and units of the curvature radius, the thickness and the focal length are all millimeter (mm).

TABLE 1

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −0.7000 | | | | |
| S1 | Aspheric | 2.2708 | 0.9051 | 5.14 | 1.54 | 56.1 | −0.0944 |
| S2 | Aspheric | 10.2546 | 0.0361 | | | | 12.5136 |
| S3 | Aspheric | 8.0365 | 0.3020 | −16.33 | 1.67 | 19.2 | −8.3655 |
| S4 | Aspheric | 4.5850 | 0.4901 | | | | −0.8218 |
| S5 | Aspheric | −434.7826 | 0.2882 | −29.71 | 1.67 | 19.2 | −35.4008 |
| S6 | Aspheric | 21.1172 | 0.0552 | | | | 0.0000 |
| S7 | Aspheric | 26.4199 | 0.4773 | 21.34 | 1.54 | 56.1 | 0.0000 |
| S8 | Aspheric | −20.6787 | 0.4837 | | | | 0.0000 |
| S9 | Aspheric | 4.5545 | 0.4090 | 78.13 | 1.57 | 37.3 | −2.2132 |
| S10 | Aspheric | 4.9075 | 0.4476 | | | | −1.8261 |
| S11 | Aspheric | 6.6125 | 0.7539 | 5.72 | 1.54 | 55.7 | −5.8917 |
| S12 | Aspheric | −5.4989 | 0.5735 | | | | −0.0736 |
| S13 | Aspheric | −3.1767 | 0.5467 | −3.33 | 1.54 | 55.7 | −0.9981 |
| S14 | Aspheric | 4.3332 | 0.2939 | | | | −0.0727 |
| S15 | Spherical | Infinite | 0.2100 | | 1.52 | 64.2 | |
| S16 | Spherical | Infinite | 0.3260 | | | | |
| S17 | Spherical | Infinite | | | | | |

As shown in Table 2, in Embodiment 1, a total effective focal length f of the optical imaging lens assembly is 5.41 mm. TTL is a distance from the object-side surface S1 of the first lens E1 to the imaging surface S17 on the optical axis, and TTL is 6.60 mm. ImgH is a half of a diagonal length of an effective pixel region on the imaging surface S17, and ImgH is 5.20 mm. Explanations about parameters of each relational expression are the same as those in Embodiment 1. Numerical values of each relational expression are listed in the following table.

TABLE 2
Embodiment 1

| | | | |
|---|---|---|---|
| f(mm) | 5.41 | f1(mm) | 5.14 |
| TTL(mm) | 6.60 | ImgH(mm) | 5.20 |
| ImgH × ImgH/TTL(mm) | 4.10 | TTL/ImgH | 1.27 |
| f × tan(½FOV)(mm) | 4.97 | f/EPD | 1.65 |
| (RII − R12)/f6 | 2.12 | (f1 − f7)/f | 1.57 |
| f2/(R4 − R3) | 4.73 | (CT1 + CT2)/(CT3 + CT4) | 1.58 |
| (fI2 − f67)/f34 | 0.27 | SAG62/SAG52 | 2.08 |
| SAG71/ET7 | −1.69 | (ET4 + ET5)/ET6 | 1.01 |

The optical imaging lens assembly in Embodiment 1 satisfies:

ImgH×ImgH/TTL=4.10 mm, wherein ImgH is a half of a diagonal length of an effective pixel region on the imaging surface, and TTL is an on-axis distance from the object-side surface of the first lens to the imaging surface;

TTL/ImgH=1.27, wherein TTL is the on-axis distance from the object-side surface of the first lens to the imaging surface, and ImgH is a half of the diagonal length of the effective pixel region on the imaging surface;

f×tan(1/2FOV)=4.97 mm, wherein f is an effective focal length of the optical imaging lens assembly, and FOV is a maximum field of view of the optical imaging lens assembly;

f/EPD=1.65, wherein f is the effective focal length of the optical imaging lens assembly, and EPD is an entrance pupil diameter of the optical imaging lens assembly;

(R11-R12)/f6=2.12, wherein R11 is a curvature radius of the object-side surface of the sixth lens, R12 is a curvature radius of the image-side surface of the sixth lens, and f6 is an effective focal length of the sixth lens;

(f1-f7)/f=1.57, wherein f1 is an effective focal length of the first lens, f7 is an effective focal length of the seventh lens, and f is the effective focal length of the optical imaging lens assembly;

f2/(R4-R3)=4.73, wherein f2 is an effective focal length of the second lens, R4 is a curvature radius of the image-side surface of the second lens, and R3 is a curvature radius of the object-side surface of the second lens;

(CT1+CT2)/(CT3+CT4)=1.58, wherein CT1 is a center thickness of the first lens on the optical axis. CT2 is a center thickness of the second lens on the optical axis, CT3 is a center thickness of the third lens on the optical axis, and CT4 is a center thickness of the fourth lens on the optical axis;

(f12-f67)/f34=0.27, wherein f12 is a combined focal length of the first lens and the second lens, f67 is a combined focal length of the sixth lens and the seventh lens, and f34 is a combined focal length of the third lens and the fourth lens;

SAG62/SAG52=2.08, wherein SAG62 is an on-axis distance from an intersection point of the image-side surface of the sixth lens and the optical axis to an effective radius vertex of the image-side surface of the sixth lens, and SAG52 is an on-axis distance from an intersection point of the image-side surface of the fifth lens and the optical axis to an effective radius vertex of the image-side surface of the fifth lens;

SAG71/ET7=−1.69, wherein SAG71 is an on-axis distance from an intersection point of an object-side surface of the seventh lens and the optical axis to an effective radius vertex of the object-side surface of the seventh lens, and ET7 is an edge thickness of the seventh lens; and

(ET4+ET5)/ET6=1.01, wherein ET4 is an edge thickness of the fourth lens. ET5 is an edge thickness of the fifth lens, and ET6 is an edge thickness of the sixth lens.

In Embodiment 1, both the object-side surface and image-side surface of any lens in the first lens E1 to the seventh lens E7 are aspheric surfaces. A surface type x of each aspheric lens may be defined through, but not limited to, the following aspheric surface formula:

$$x = \frac{{ch}^{2}}{1 + \sqrt{1 - ( k + 1 ) {c}^{2} {h}^{2}}} + Σ {Aih}^{i} , \qquad ( 1 )$$

wherein x is a distance vector height from a vertex of the aspheric surface when the aspheric surface is at a height of h along the optical axis direction; c is a paraxial curvature of the aspheric surface, c=1/R (namely, the paraxial curvature c is a reciprocal of the curvature radius R in Table 1); k is a conic coefficient; and Ai is a correction coefficient of the i-th order of the aspheric surface.

In Embodiment 1, both the object-side surface and image-side surface of any lens in the first lens E1 to the seventh lens E7 are aspheric surfaces. Table 3 shows high-order coefficients A₄, A₆, A₈, A₁₀, A₁₂, A₁₄, A₁₆, A₁₈, A₂₀, A₂₂, A₂₄, A₂₆, A₂₈ and A₃₀ that can be used for each of the aspheric mirror surfaces S1-S14 in Embodiment 1.

TABLE 3

| Surface | | | | | | | |
|---|---|---|---|---|---|---|---|
| number | A4 | A6 | A8 | A10 | A12 | A14 | A16 |
| S1 | −3.7898E−04 | 1.4216E−02 | −5.3899E−02 | 1.4296E−01 | −2.5372E−01 | 3.0498E−01 | −2.4922E−01 |
| S2 | −4.6304E−02 | 4.1196E−02 | 6.7586E−02 | −3.0289E−01 | 5.5216E−01 | −6.1915E−01 | 4.5348E−01 |
| S3 | −4.5633E−02 | 5.5103E−02 | 7.6075E−03 | −1.1269E−01 | 1.8798E−01 | −2.2031E−01 | 2.8804E−01 |
| S4 | −6.0378E−03 | 2.1714E−04 | 1.0215E−01 | −3.8068E−01 | 8.0485E−01 | −1.1046E+00 | 1.0338E+00 |
| S5 | −3.8954E−02 | 2.7754E−02 | −1.0719E−01 | 2.2125E−01 | −3.2215E−01 | 3.6809E−01 | −3.7872E−01 |
| S6 | −6.4197E−02 | 1.0986E−01 | −2.5383E−01 | 3.7295E−01 | −3.8515E−01 | 3.0686E−01 | −2.1890E−01 |
| S7 | −7.0349E−02 | 1.8866E−01 | −6.2186E−01 | 1.7008E+00 | −3.6836E+00 | 5.9898E+00 | −7.1769E+00 |
| S8 | −5.1340E−02 | 3.7793E−02 | −7.9437E−04 | −1.9800E−01 | 6.3951E−01 | −1.1762E+00 | 1.4454E+00 |
| S9 | −7.5107E−02 | 6.8550E−02 | −1.6470E−01 | 3.3740E−01 | −4.9734E−01 | 5.1963E−01 | −3.9096E−01 |
| S10 | −7.2618E−02 | 3.1295E−02 | −3.8731E−02 | 4.8683E−02 | −4.5664E−02 | 3.0266E−02 | −1.4301E−02 |
| S11 | −1.6429E−02 | −1.1570E−02 | 9.5047E−03 | −8.6859E−03 | 6.4240E−03 | −3.1194E−03 | 9.8004E−04 |
| S12 | 2.5461E−02 | −2.7978E−02 | 2.7146E−02 | −2.5240E−02 | 1.6318E−02 | −6.8058E−03 | 1.8894E−03 |
| S13 | −3.5033E−02 | 1.2021E−02 | −8.1917E−03 | 4.3838E−03 | −1.1228E−03 | 1.4033E−04 | −4.5216E−06 |
| S14 | −4.5837E−02 | 6.5437E−03 | 5.5898E−05 | −8.4486E−04 | 3.6027E−04 | −8.8231E−05 | 1.4409E−05 |
| Surface | | | | | | | |
| number | A18 | A20 | A22 | A24 | A26 | A28 | A30 |
| S1 | 1.3651E−01 | −4.7413E−02 | 8.5149E−03 | 2.2531E−04 | −4.6579E−04 | 9.2029E−05 | −6.3156E−08 |
| S2 | −2.1223E−01 | 5.4912E−02 | −1.4827E−03 | −4.0630E−03 | 1.3773E−03 | −2.0120E−04 | 1.1621E−05 |
| S3 | −3.8140E−01 | 3.7818E−01 | −2.5178E−01 | 1.0914E−01 | −2.9610E−02 | 4.5736E−03 | −3.0732E−04 |
| S4 | −6.8544E−01 | 3.4225E−01 | −1.4148E−01 | 5.1022E−02 | −1.4530E−02 | 2.6323E−03 | −2.1372E−04 |
| S5 | 3.7635E−01 | −3.4099E−01 | 2.4498E−01 | −1.2629E−01 | 4.3018E−02 | −8.6019E−03 | 7.6143E−04 |
| S6 | 1.5267E−01 | −1.1356E−01 | 6.1245E−02 | −2.3049E−02 | 5.7162E−03 | −8.5127E−04 | 5.8282E−05 |
| S7 | 6.3155E+00 | −4.0554E+00 | 1.8753E+00 | −6.0759E−01 | 1.3086E−01 | −1.6829E−02 | 9.7769E−04 |
| S8 | −1.2457E+00 | 7.6509E−01 | −3.3381E−01 | 1.0119E−01 | −2.0271E−02 | 2.4134E−03 | −1.2929E−04 |
| S9 | 2.1380E−01 | −8.4938E−02 | 2.4233E−02 | −4.8322E−03 | 6.3867E−04 | −5.0216E−05 | 1.7760E−06 |
| S10 | 4.8965E−03 | −1.2068E−03 | 2.1087E−04 | −2.5411E−05 | 2.0070E−06 | −9.3583E−08 | 1.9563E−09 |
| S11 | −2.0584E−04 | 2.9777E−05 | −3.0102E−06 | 2.1134E−07 | −9.9272E−09 | 2.8305E−10 | −3.7255E−12 |
| S12 | −3.6064E−04 | 4.8143E−05 | −4.4960E−06 | 2.8825E−07 | −1.2102E−08 | 2.9998E−10 | −3.3313E−12 |
| S13 | −1.2143E−06 | 2.1289E−07 | −1.7596E−08 | 8.7687E−10 | −2.6905E−11 | 4.7090E−13 | −3.6143E−15 |
| S14 | −1.6436E−06 | 1.3318E−07 | −7.6552E−09 | 3.0566E−10 | −8.0719E−12 | 1.2689E−13 | −8.9964E−16 |

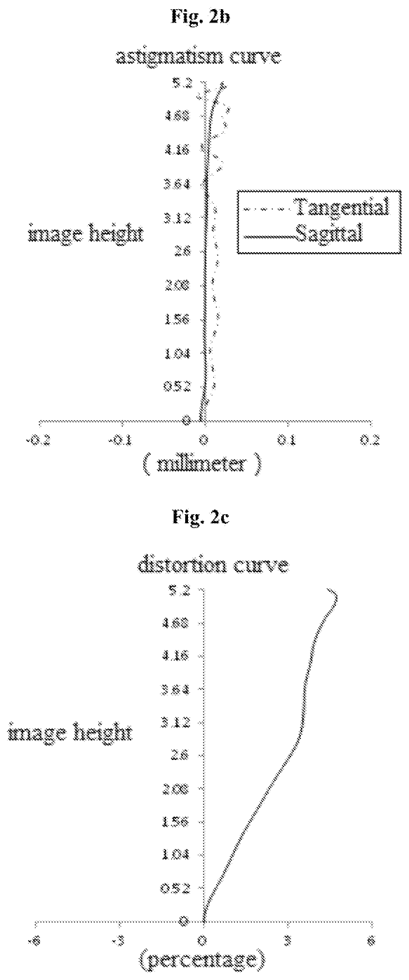

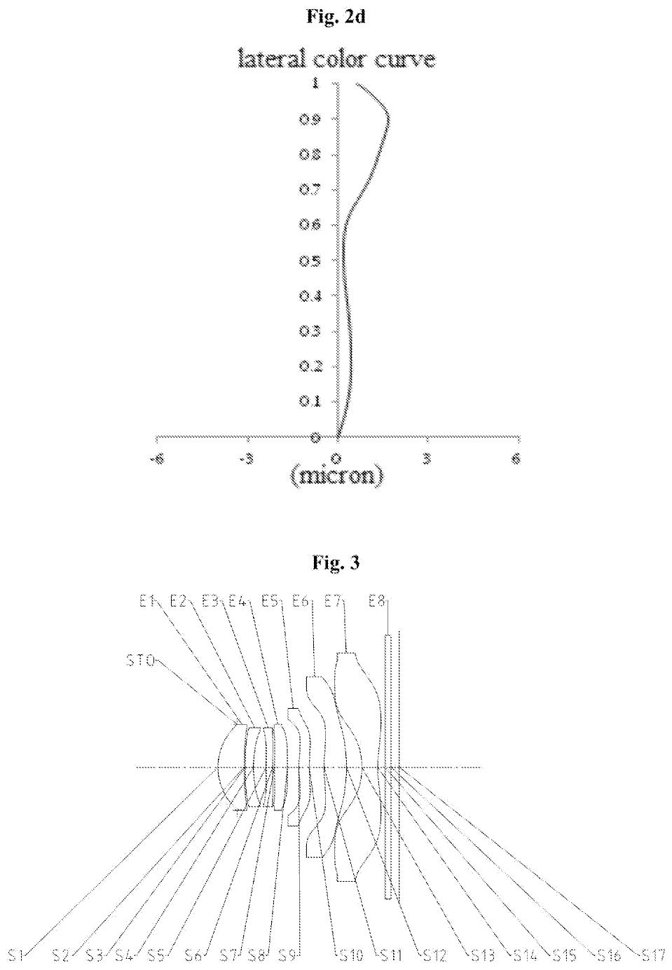

FIG. 2a shows a longitudinal aberration curve of the optical imaging lens assembly according to Embodiment 1 to represent deviations of a convergence focal point after light with different wavelengths passes through the lens assembly. FIG. 2b shows an astigmatism curve of the optical imaging lens assembly according to Embodiment 1 to represent a tangential image surface curvature and a sagittal image surface curvature. FIG. 2c shows a distortion curve of the optical imaging lens assembly according to Embodiment 1 to represent distortion values corresponding to different image heights. FIG. 2d shows a lateral color curve of the optical imaging lens assembly according to Embodiment 1 to represent deviations of different image heights on the imaging surface after the light passes through the lens assembly. According to FIGS. 2a-2d, it can be seen that the optical imaging lens assembly provided in Embodiment 1 may achieve high imaging quality.

### Embodiment 2

FIG. 3 is a structure diagram of a lens group of an optical imaging lens assembly according to Embodiment 2 of the disclosure. The optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a negative refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a concave surface. The fifth lens E5 has a positive refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh tens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

Table 4 shows a table of basic parameters for the optical imaging lens assembly of Embodiment 2, and units of the curvature radius, the thickness and the focal length are all millimeter (mm).

TABLE 4

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −0.6950 | | | | |
| S1 | Aspheric | 2.2772 | 0.9550 | 5.13 | 1.54 | 56.1 | −0.1312 |
| S2 | Aspheric | 10.3732 | 0.0345 | | | | −6.9219 |
| S3 | Aspheric | 8.7338 | 0.3021 | −15.53 | 1.67 | 19.2 | −12.6914 |
| S4 | Aspheric | 4.7059 | 0.4590 | | | | −2.2739 |
| S5 | Aspheric | 19.0488 | 0.2424 | −32.65 | 1.67 | 19.2 | 7.4089 |
| S6 | Aspheric | 10.1825 | 0.0597 | | | | 0.0000 |
| S7 | Aspheric | 13.1530 | 0.4770 | 24.52 | 1.54 | 56.1 | 0.0000 |
| S8 | Aspheric | 769.2308 | 0.4161 | | | | 0.0000 |
| S9 | Aspheric | 4.5146 | 0.3732 | 63.12 | 1.57 | 37.3 | −3.3074 |
| S10 | Aspheric | 5.0069 | 0.5402 | | | | −0.0348 |
| S11 | Aspheric | 6.5217 | 0.8193 | 5.69 | 1.54 | 55.7 | −4.6534 |
| S12 | Aspheric | −5.4881 | 0.5604 | | | | −0.2397 |
| S13 | Aspheric | −3.0805 | 0.5763 | −3.33 | 1.54 | 55.7 | −1.1778 |
| S14 | Aspheric | 4.5395 | 0.2712 | | | | −0.2734 |
| S15 | Spherical | Infinite | 0.2100 | | 1.52 | 64.2 | |
| S16 | Spherical | Infinite | 0.3020 | | | | |
| S17 | Spherical | Infinite | | | | | |

As shown in Table 5, in Embodiment 2, a total effective focal length f of the optical imaging lens assembly is 5.41 mm. TTL is a distance from the object-side surface S1 of the first lens E1 to the imaging surface S17 on the optical axis, and TTL is 6.60 mm. ImgH is a half of a diagonal length of an effective pixel region on the imaging surface S17, and ImgH is 5.20 mm. Explanations about parameters of each relational expression are the same as those in Embodiment 1. Numerical values of each relational expression are listed in the following table.

TABLE 5
Embodiment 2

| | | | |
|---|---|---|---|
| f(mm) | 5.41 | f1(mm) | 5.13 |
| TTL(mm) | 6.60 | ImgH(mm) | 5.20 |
| ImgH × ImgH/TTL(mm) | 4.10 | TTL/ImgH | 1.27 |
| f × tan(½FOV)(mm) | 4.97 | f/EPD | 1.65 |
| (R11 − R12)/f6 | 2.11 | (f1 − f7)/f | 1.57 |
| f2/(R4 − R3) | 3.86 | (CT1 + CT2)/(CT3 + CT4) | 1.75 |
| (fI2 − f67)/f34 | 0.20 | SAG62/SAG52 | 2.19 |
| SAG71/ET7 | −1.38 | (ET4 + ET5)/ET6 | 1.06 |

In Embodiment 2, both the object-side surface and image-side surface of any lens in the first lens E1 to the seventh lens E7 are aspheric surfaces. Table 6 shows high-order coefficients A₄, A₆, A₈, A₁₀, A₁₂, A₁₄, A₁₆, A₁₈, A₂₀, A₂₂, A₂₄, A₂₆, A₂₈ and A₃₀ that can be used for each of the aspheric mirror surfaces S1-S14 in Embodiment 2.

TABLE 6

| Surface | | | | | | | |
|---|---|---|---|---|---|---|---|
| number | A4 | A6 | A8 | A10 | A12 | A14 | A16 |
| S1 | −3.6880E−04 | 1.3647E−02 | −5.1041E−02 | 1.3355E−01 | −2.3381E−01 | 2.7725E−01 | −2.2349E−01 |
| S2 | −4.4117E−02 | 3.8311E−02 | 6.1351E−02 | −2.6838E−01 | 4.7756E−01 | −5.2269E−01 | 3.7368E−01 |
| S3 | −4.3933E−02 | 5.2053E−02 | 7.0512E−03 | −1.0248E−01 | 1.6774E−01 | −1.9290E−01 | 2.4745E−01 |
| S4 | −5.6282E−03 | 1.9543E−04 | 8.8763E−02 | −3.1937E−01 | 6.5191E−01 | −8.6381E−01 | 7.8063E−01 |
| S5 | −3.5929E−02 | 2.4584E−02 | −9.1192E−02 | 1.8077E−01 | −2.5778E−01 | 2.7738E−01 | −2.7264E−01 |
| S6 | −6.1350E−02 | 1.0263E−01 | −2.3181E−01 | 3.3297E−01 | −3.3614E−01 | 2.6175E−01 | −1.8257E−01 |
| S7 | −6.9458E−02 | 1.8511E−01 | −6.0603E−01 | 1.6475E+00 | −3.5455E+00 | 5.7286E+00 | −6.8223E+00 |
| S8 | −5.1432E−02 | 3.7895E−02 | −7.9722E−04 | −1.9859E−01 | 6.4297E−01 | −1.1836E+00 | 1.4558E+00 |
| S9 | −8.9945E−02 | 8.9835E−02 | −2.3620E−01 | 5.2951E−01 | −8.5415E−01 | 9.7662E−01 | −8.0411E−01 |
| S10 | −8.4947E−02 | 3.9594E−02 | −5.2999E−02 | 7.2050E−02 | −7.3095E−02 | 5.2294E−02 | −2.6778E−02 |
| S11 | −1.4675E−02 | −9.7666E−03 | 7.5828E−03 | −6.5491E−03 | 4.5777E−03 | −2.1008E−03 | 6.2378E−04 |
| S12 | 2.3064E−02 | −2.2768E−02 | 2.0624E−02 | −1.7903E−02 | 1.0806E−02 | −4.2077E−03 | 1.0906E−03 |
| S13 | −3.2277E−02 | 1.0631E−02 | −6.9534E−03 | 3.5799E−03 | −8.7805E−04 | 1.0534E−04 | −3.2579E−06 |
| S14 | −3.9334E−02 | 6.2808E−03 | 3.8171E−04 | −6.4513E−04 | 2.1328E−04 | −4.0942E−05 | 5.1661E−06 |

| Surface | | | | | | | |
|---|---|---|---|---|---|---|---|
| number | A18 | A20 | A22 | A24 | A26 | A28 | A30 |
| S1 | 1.2076E−01 | −4.1375E−02 | 7.3301E−03 | 1.9134E−04 | −3.9020E−04 | 7.6052E−05 | −5.1485E−06 |
| S2 | −1.7070E−01 | 4.3112E−02 | −1.1362E−03 | −3.0392E−03 | 1.0056E−03 | −1.4339E−04 | 8.0843E−06 |
| S3 | −3.2150E−01 | 3.1279E−01 | −2.0433E−01 | 8.6903E−02 | −2.3135E−02 | 3.5061E−03 | −2.3117E−04 |
| S4 | −4.9967E−01 | 2.4088E−01 | −9.6136E−02 | 3.3474E−02 | −9.2034E−03 | 1.5098E−03 | −1.2619E−04 |
| S5 | 2.6158E−01 | −2.2762E−01 | 1.5705E−01 | −7.7757E−02 | 2.5436E−02 | −4.8848E−03 | 4.1527E−04 |
| S6 | 1.3263E−01 | −9.0514E−02 | 4.7721E−02 | −1.7556E−02 | 4.2564E−03 | −6.1966E−04 | 4.1474E−05 |
| S7 | 5.9367E+00 | −3.8052E+00 | 1.7484E+00 | −5.6288E−01 | 1.2047E−01 | −1.59393E−02 | 8.8861E−04 |
| S8 | −1.2558E+00 | 7.7199E−01 | −3.3713E−01 | 1.0228E−01 | −2.0509E−01 | 2.4439E−03 | −1.3105E−04 |
| S9 | 4.8120E−01 | −2.0921E−01 | 6.5316E−02 | −1.4253E−02 | 2.0616E−03 | −1.7738E−04 | 6.8654E−06 |
| S10 | 9.9164E−03 | −2.6434E−03 | 4.9955E−04 | −6.5110E−05 | 5.5619E−06 | −2.8049E−07 | 6.3416E−09 |
| S11 | −1.2382E−04 | 1.6928E−05 | −1.6173E−06 | 1.0731E−07 | −4.7641E−09 | 1.2838E−10 | −1.5969E−12 |
| S12 | −1.9434E−04 | 2.4221E−05 | −2.1119E−06 | 1.2641E−07 | −4.9549E−09 | 1.1466E−10 | −1.1888E−12 |
| S13 | −8.3979E−07 | 1.4132E−07 | −1.1212E−08 | 5.3630E−10 | −1.5795E−11 | 2.6534E−13 | −1.9549E−15 |
| S14 | −4.4464E−07 | 2.6292E−08 | −1.0455E−09 | 2.6184E−11 | −3.4382E−13 | 7.0894E−16 | 2.4076E−17 |

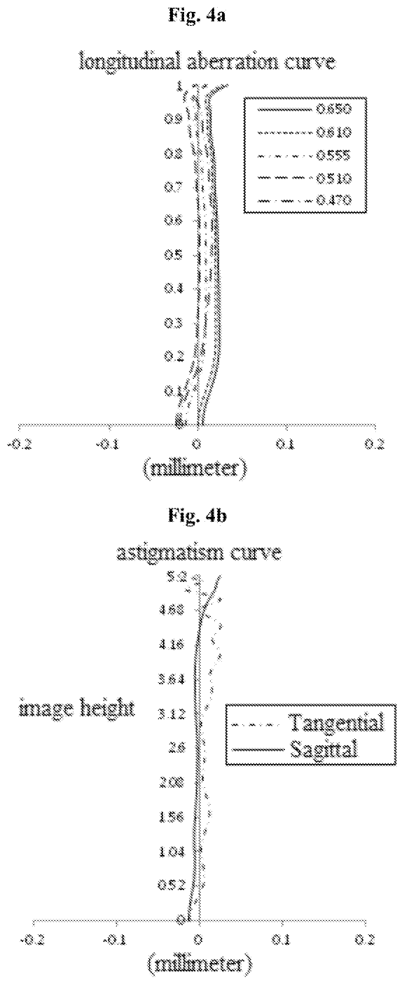

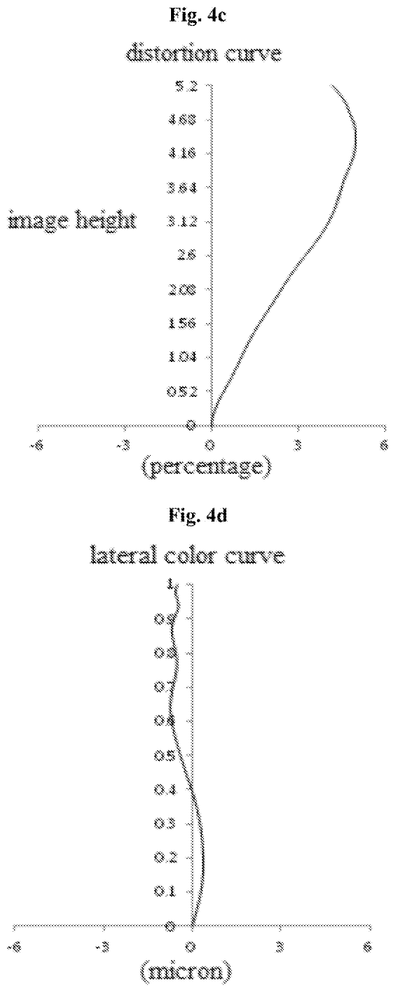

FIG. 4a shows a longitudinal aberration curve of the optical imaging lens assembly according to Embodiment 2 to represent deviations of a convergence focal point after light with different wavelengths passes through the lens assembly. FIG. 4b shows an astigmatism curve of the optical imaging lens assembly according to Embodiment 2 to represent a tangential image surface curvature and a sagittal image surface curvature. FIG. 4c shows a distortion curve of the optical imaging lens assembly according to Embodiment 2 to represent distortion values corresponding to different image heights. FIG. 4d shows a lateral color curve of the optical imaging lens assembly according to Embodiment 2 to represent deviations of different image heights on the imaging surface after the light passes through the lens assembly. According to FIGS. 4a-4d, it can be seen that the optical imaging lens assembly provided in Embodiment 2 may achieve high imaging quality.

### Embodiment 3

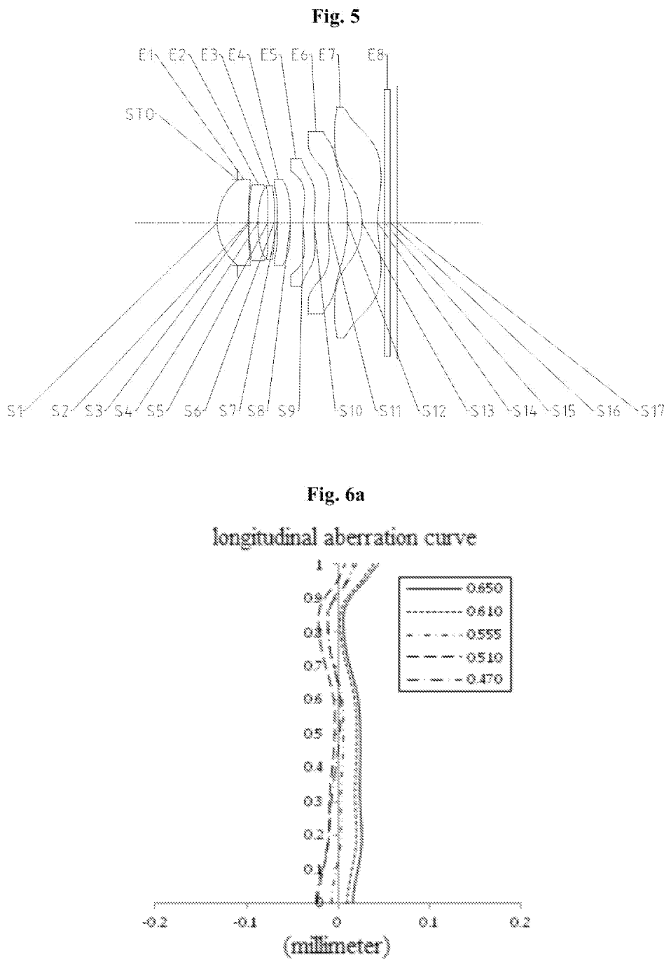

FIG. 5 is a structure diagram of a lens group of an optical imaging lens assembly according to Embodiment 3 of the disclosure. The optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 Is a concave surface. The fourth lens E4 has a positive refractive power, an object-side surface S7 thereof is a concave surface, while an image-side surface S8 is a convex surface. The fifth lens E5 has a positive refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

Table 7 shows a table of basic parameters for the optical imaging lens assembly of Embodiment 3, and units of the curvature radius, the thickness and the focal length are all millimeter (mm).

TABLE 7

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −0.7320 | | | | |
| S1 | Aspheric | 2.2087 | 1.1201 | 4.89 | 1.54 | 56.1 | −0.1043 |
| S2 | Aspheric | 10.5048 | 0.0357 | | | | 10.9445 |
| S3 | Aspheric | 11.0424 | 0.3200 | −12.24 | 1.67 | 19.2 | 15.1440 |
| S4 | Aspheric | 4.6819 | 0.3614 | | | | 3.5985 |
| S5 | Aspheric | 14.5825 | 0.2251 | 111.00 | 1.67 | 19.2 | −90.0000 |
| S6 | Aspheric | 17.9768 | 0.1249 | | | | 0.0000 |
| S7 | Aspheric | −58.2257 | 0.4715 | 52.97 | 1.54 | 56.1 | 0.0000 |
| S8 | Aspheric | −19.3667 | 0.4667 | | | | 0.0000 |
| S9 | Aspheric | 5.1030 | 0.3926 | 73.80 | 1.57 | 37.3 | −5.4950 |
| S10 | Aspheric | 5.6447 | 0.5201 | | | | −1.5728 |
| S11 | Aspheric | 9.1374 | 0.7032 | 6.05 | 1.54 | 55.7 | −0.5099 |
| S12 | Aspheric | −4.8966 | 0.5260 | | | | −1.1581 |
| S13 | Aspheric | −3.1598 | 0.5678 | −3.34 | 1.54 | 55.7 | −1.0000 |
| S14 | Aspheric | 4.4065 | 0.2468 | | | | −0.0518 |
| S15 | Spherical | Infinite | 0.2100 | | 1.52 | 64.2 | |
| S16 | Spherical | Infinite | 0.2669 | | | | |
| S17 | Spherical | Infinite | | | | | |

As shown in Table 8, in Embodiment 3, a total effective focal length f of the optical imaging lens assembly is 5.41 mm. TTL is a distance from the object-side surface S1 of the first lens E1 to the imaging surface S17 on the optical axis, and TTL is 6.56 mm. ImgH is a half of a diagonal length of an effective pixel region on the imaging surface S17, and ImgH is 5.20 mm. Explanations about parameters of each relational expression are the same as those in Embodiment 1. Numerical values of each relational expression are listed in the following table.

TABLE 8
Embodiment 3

| | | | |
|---|---|---|---|
| f(mm) | 5.41 | f1(mm) | 4.89 |
| TTL(mm) | 6.56 | ImgH(mm) | 5.20 |
| ImgH × ImgH/TTL(mm) | 4.12 | TTL/ImgH | 1.26 |
| f × tan(½FOV)(mm) | 5.00 | f/EPD | 1.65 |
| (RII − R12)/f6 | 2.32 | (f1 − f7)/f | 1.52 |
| f2/(R4 − R3) | 1.93 | (CT1 + CT2)/(CT3 + CT4) | 2.07 |
| (fI2 − f67)/f34 | 0.49 | SAG62/SAG52 | 1.83 |
| SAG71/ET7 | −3.55 | (ET4 + ET5)/ET6 | 1.19 |

In Embodiment 3, both the object-side surface and image-side surface of any lens in the first lens E1 to the seventh lens E7 are aspheric surfaces. Table 9 shows high-order coefficients A₄, A₆, A₈, A₁₀, A₁₂, A₁₄, A₁₆, A₁₈, A₂₀, A₂₂, A₂₄, A₂₆, A₂₈ and A₃₀ that can be used for each of the aspheric mirror surfaces S1-14 in Embodiment 3.

TABLE 9

| Surface | | | | | | | |
|---|---|---|---|---|---|---|---|
| number | A4 | A6 | A8 | A10 | A12 | A14 | A16 |
| S1 | −3.4532E−04 | 1.2385E−02 | −4.4749E−02 | 1.1330E−01 | −1.9194E−01 | 2.2024E−01 | −1.7179E−01 |
| S2 | −4.4760E−02 | 3.9151E−02 | 6.3151E−02 | −2.7826E−01 | 4.9872E−01 | −5.4982E−01 | 3.9593E−01 |
| S3 | −4.5257E−02 | 5.4425E−02 | 7.4828E−03 | −1.1038E−01 | 1.8338E−01 | −2.1403E−01 | 2.7868E−01 |
| S4 | −7.0217E−03 | 2.7233E−04 | 1.3816E−01 | −5.5522E−01 | 1.2659E+00 | −1.8736E+00 | 1.8909E+00 |
| S5 | −3.3718E−02 | 2.2350E−02 | −8.0312E−02 | 1.5422E−01 | −2.0891E−01 | 2.2208E−01 | −2.1147E−01 |
| S6 | −6.0224E−02 | 9.9818E−02 | −2.2338E−01 | 3.1789E−01 | −3.1797E−01 | 2.4532E−01 | −1.6953E−01 |
| S7 | −6.6184E−02 | 1.7217E−01 | −5.5024E−01 | 1.4601E+00 | −3.0674E+00 | 4.8379E+00 | −5.6241E+00 |
| S8 | −4.5913E−02 | 3.1962E−02 | −6.3532E−04 | −1.4975E−01 | 4.5740E−01 | −7.9555E−01 | 9.2453E−01 |
| S9 | −7.0605E−02 | 6.2479E−02 | −1.4554E−01 | 2.8908E−01 | −4.1315E−01 | 4.1853E−01 | −3.0531E−01 |
| S10 | −6.9123E−02 | 2.9063E−02 | −3.6093E−02 | 4.3035E−02 | −3.9384E−02 | 2.6417E−02 | −1.1741E−02 |
| S11 | −1.4558E−02 | −9.6500E−03 | 7.4623E−03 | −6.4193E−03 | 4.4690E−03 | −2.0427E−03 | 6.0411E−04 |
| S12 | 2.3779E−02 | −2.3834E−02 | 2.1921E−02 | −1.9321E−02 | 1.1841E−02 | −4.6818E−03 | 1.2321E−03 |
| S13 | −3.2286E−02 | 1.0734E−02 | −7.0294E−03 | 3.6238E−03 | −8.8877E−04 | 1.0599E−04 | −3.0208E−06 |
| S14 | −3.7835E−02 | 4.2342E−03 | 9.3778E−04 | −6.8413E−04 | 1.9985E−04 | −3.6980E−05 | 4.6668E−06 |
| Surface | | | | | | | |
| number | A18 | A20 | A22 | A24 | A26 | A28 | A30 |
| S1 | 8.9825E−02 | −2.9780E−02 | 5.1052E−03 | 1.2895E−04 | −2.5446E−04 | 4.7991E−05 | −3.1438E−06 |
| S2 | −1.8217E−01 | 4.5344E−02 | −1.2302E−03 | −3.3146E−03 | 1.1647E−03 | −1.5866E−04 | 9.0100E−06 |
| S3 | −3.6748E−01 | 3.6288E−01 | −2.4060E−01 | 1.0386E−01 | −2.8062E−02 | 4.3166E−03 | −2.8886E−04 |
| S4 | −1.3521E+00 | 7.2805E−01 | −3.2455E−01 | 1.2622E−01 | −3.8763E−02 | 7.5731E−03 | −6.6309E−04 |
| S5 | 1.9554E−01 | −1.6568E−01 | 1.1074E−01 | −5.3113E−02 | 1.6832E−02 | −3.131E−03 | 2.5788E−04 |
| S6 | 1.2202E−01 | −8.2506E−02 | 4.3097E−02 | −1.5709E−02 | 3.7734E−03 | −5.4428E−04 | 3.6093E−05 |
| S7 | 4.7990E+00 | −2.9890E+00 | 1.3406E+00 | −4.2131E−01 | 8.8015E−02 | −1.0978E−02 | 6.1864E−04 |
| S8 | −7.5351E−01 | 4.3765E−01 | −1.8057E−01 | 5.1764E−02 | −9.8062E−03 | 1.1041E−03 | −5.5937E−05 |
| S9 | 1.5188E−01 | −6.2354E−02 | 1.7248E−02 | −3.3347E−03 | 4.2733E−04 | −3.2576E−05 | 1.1171E−06 |
| S10 | 3.9219E−03 | −9.4307E−04 | 1.6077E−04 | −1.8902E−05 | 1.4566E−06 | −6.6262E−08 | 1.3514E−09 |
| S11 | −1.1944E−04 | 1.6264E−05 | −1.5476E−06 | 1.0228E−07 | −4.5225E−09 | 1.2138E−10 | −1.5038E−12 |
| S12 | −2.2294E−04 | 2.8212E−05 | −2.4976E−06 | 1.5179E−07 | −6.0413E−09 | 1.4195E−10 | −1.4944E−12 |
| S13 | −9.0606E−07 | 1.4977E−07 | −1.1867E−08 | 5.6878E−10 | −1.6809E−11 | 2.8359E−13 | −2.0993E−15 |
| S14 | −4.1346E−07 | 2.6014E−08 | −1.1624E−09 | 3.6371E−11 | −7.6861E−13 | 1.0059E−14 | −6.3102E−17 |

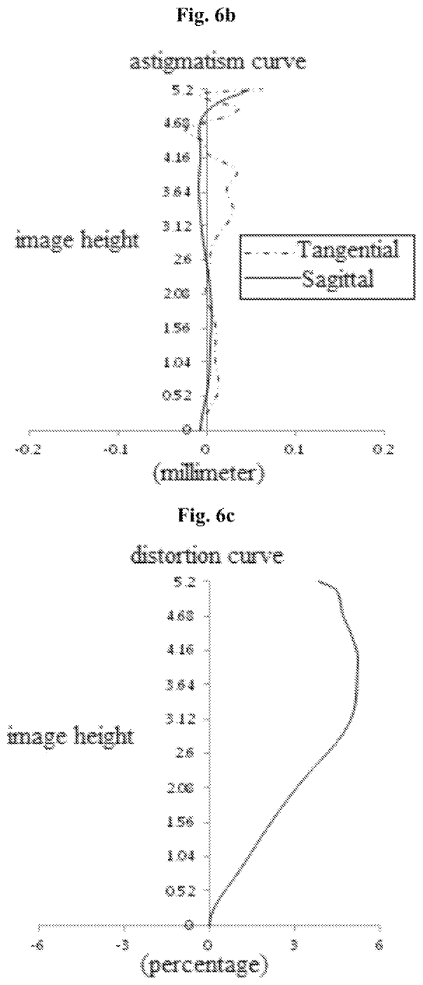

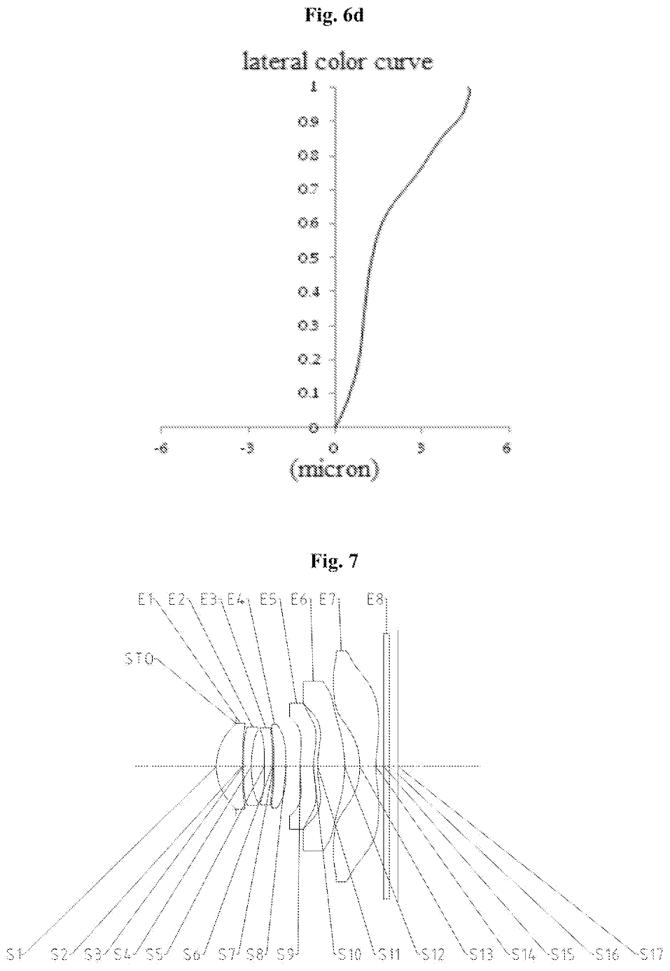

FIG. 6a shows a longitudinal aberration curve of the optical imaging lens assembly according to Embodiment 3 to represent deviations of a convergence focal point after light with different wavelengths passes through the lens assembly. FIG. 6b shows an astigmatism curve of the optical imaging lens assembly according to Embodiment 3 to represent a tangential image surface curvature and a sagittal image surface curvature. FIG. 6c shows a distortion curve of the optical imaging lens assembly according to Embodiment 3 to represent distortion values corresponding to different image heights. FIG. 6d shows a lateral color curve of the optical imaging lens assembly according to Embodiment 3 to represent deviations of different image heights on the imaging surface after the light passes through the lens assembly. According to FIGS. 6a-6d, it can be seen that the optical imaging lens assembly provided in Embodiment 3 may achieve high imaging quality.

### Embodiment 4

FIG. 7 is a structure diagram of a lens group of an optical imaging lens assembly according to Embodiment 4 of the disclosure. The optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a negative refractive power, an object-side surface S5 thereof is a convex surface, while an image-side surface S6 is a concave surface. The fourth lens E4 has a positive refractive power, an object-side surface S7 thereof is a convex surface, while an image-side surface S8 is a convex surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

Table 10 shows a table of basic parameters for the optical imaging lens assembly of Embodiment 4, and units of the curvature radius, the thickness and the focal length are all millimeter (mm).

TABLE 10

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −0.7220 | | | | |
| S1 | Aspheric | 2.2373 | 0.9423 | 5.05 | 1.54 | 56.1 | −0.1021 |
| S2 | Aspheric | 10.1461 | 0.0340 | | | | 14.9570 |
| S3 | Aspheric | 8.5792 | 0.2982 | −17.97 | 1.67 | 19.2 | −6.0416 |
| S4 | Aspheric | 4.9626 | 0.4746 | | | | −0.9230 |
| S5 | Aspheric | 319.7323 | 0.2900 | −30.60 | 1.67 | 19.2 | −90.0000 |
| S6 | Aspheric | 19.4615 | 0.0438 | | | | 0.0000 |
| S7 | Aspheric | 31.6320 | 0.4554 | 18.10 | 1.54 | 56.1 | 0.0000 |
| S8 | Aspheric | −14.2781 | 0.5115 | | | | 0.0000 |
| S9 | Aspheric | 5.5658 | 0.4874 | −11.10 | 1.57 | 37.3 | −10.9773 |
| S10 | Aspheric | 2.8680 | 0.1536 | | | | −7.9147 |
| S11 | Aspheric | 3.6729 | 0.9843 | 4.03 | 1.54 | 55.7 | −12.2301 |
| S12 | Aspheric | −4.7816 | 0.5498 | | | | −1.0626 |
| S13 | Aspheric | −3.2086 | 0.5887 | −3.34 | 1.54 | 55.7 | −1.0054 |
| S14 | Aspheric | 4.3344 | 0.2781 | | | | −0.0957 |
| S15 | Spherical | Infinite | 0.2100 | | 1.52 | 64.2 | |
| S16 | Spherical | Infinite | 0.3085 | | | | |
| S17 | Spherical | Infinite | | | | | |

As shown in Table 11, in Embodiment 4, a total effective focal length f of the optical imaging lens assembly is 5.42 mm. TTL is a distance from the object-side surface S1 of the first lens E1 to the imaging surface S17 on the optical axis, and TTL is 6.61 mm. ImgH is a half of a diagonal length of an effective pixel region on the imaging surface S17, and ImgH is 5.20 mm. Explanations about parameters of each relational expression are the same as those in Embodiment 1. Numerical values of each relational expression are listed in the following table.

TABLE 11
Embodiment 4

| | | | |
|---|---|---|---|
| f(mm) | 5.42 | f1(mm) | 5.05 |
| TTL(mm) | 6.61 | ImgH(mm) | 5.20 |
| ImgH × ImgH/TTL(mm) | 4.09 | TTL/ImgH | 1.27 |
| f × tan(½FOV)(mm) | 5.00 | f/EPD | 1.65 |
| (RII − R12)/f6 | 2.10 | (f1 − f7)/f | 1.55 |
| f2/(R4 − R3) | 4.97 | (CT1 + CT2)/(CT3 + CT4) | 1.66 |
| (fI2 − f67)/f34 | −0.64 | SAG62/SAG52 | 2.17 |
| SAG71/ET7 | −2.42 | (ET4 + ET5)/ET6 | 0.99 |

In Embodiment 4, both the object-side surface and image-side surface of any lens in the first lens E1 to the seventh lens E7 are aspheric surfaces. Table 12 shows high-order coefficients A₄, A₆, A₈, A₁₀, A₁₂, A₁₄, A₁₆, A₁₈, A₂₀, A₂₂, A₂₄, A₂₆, A₂₈ and A₃₀ that can be used for each of the aspheric mirror surfaces S1-S14 in Embodiment 4.

TABLE 12

| Surface | | | | | | | |
|---|---|---|---|---|---|---|---|
| number | A4 | A6 | A8 | A10 | A12 | A14 | A16 |
| S1 | −3.9506E−04 | 1.5131E−02 | −5.8569E−02 | 1.5881E−01 | −2.8741E−01 | 3.5273E−01 | −2.9429E−01 |
| S2 | −5.0010E−02 | 4.6238E−02 | 7.8835E−02 | −3.6718E−01 | 6.9562E−01 | −8.1062E−01 | 6.1702E−01 |
| S3 | −4.9102E−02 | 6.1506E−02 | 8.8082E−03 | −1.3534E−01 | 2.3420E−01 | −2.8473E−01 | 3.8615E−01 |
| S4 | −6.4157E−03 | 2.3784E−04 | 1.1534E−01 | −4.4306E−01 | 9.8561E−01 | −1.3661E+00 | 1.3179E+00 |
| S5 | −4.2132E−02 | 3.1218E−02 | −1.2540E−01 | 2.6917E−01 | −4.0759E−01 | 4.8434E−01 | −5.1553E−01 |
| S6 | −6.9882E−02 | 1.2477E−01 | −3.0077E−01 | 4.6108E−01 | −4.9679E−01 | 4.1288E−01 | −3.0735E−01 |
| S7 | −7.7637E−02 | 2.1875E−01 | −7.5714E−01 | 2.1761E+00 | −4.9512E+00 | 8.4577E+00 | −1.0649E+01 |
| S8 | −5.7138E−02 | 4.4373E−02 | −9.8394E−04 | −2.5873E−01 | 8.8159E−01 | −1.7105E+00 | 2.2178E+00 |
| S9 | −7.0717E−02 | 6.2628E−02 | −1.4601E−01 | 2.9023E−01 | −4.1512E−01 | 4.2086E−01 | −3.0726E−01 |
| S10 | −6.8066E−02 | 2.8399E−02 | −3.4029E−02 | 4.1410E−02 | −3.7605E−02 | 2.4083E−02 | −1.1039E−02 |
| S11 | −1.9320E−02 | −1.4753E−02 | 1.3143E−02 | −1.3024E−02 | 1.0446E−02 | −5.5003E−03 | 1.8739E−03 |
| S12 | 2.7549E−02 | −2.9722E−02 | 2.9425E−02 | −2.7916E−02 | 1.8415E−02 | −7.8370E−03 | 2.2199E−03 |
| S13 | −3.4358E−02 | 1.1676E−02 | −7.8791E−03 | 4.1852E−03 | −1.0591E−03 | 1.3109E−04 | −4.1831E−06 |
| S14 | −5.1058E−02 | 1.3122E−02 | −2.4793E−03 | 2.0057E−04 | 3.7004E−05 | −1.5873E−05 | 2.8257E−06 |
| Surface | | | | | | | |
| number | A18 | A20 | A22 | A24 | A26 | A28 | A30 |
| S1 | 1.6458E−01 | −5.8361E−02 | 1.0701E−02 | 2.8911E−04 | −6.1022E−04 | 1.2310E−04 | −8.6251E−06 |
| S2 | −3.0009E−01 | 8.0894E−02 | −2.2643E−03 | −6.4483E−03 | 2.2716E−03 | −3.4487E−04 | 2.0702E−05 |
| S3 | −5.3038E−01 | 5.4554E−01 | −3.7675E−01 | 1.6940E−01 | −4.7676E−02 | 7.5389E−03 | −5.3245E−04 |
| S4 | −9.0074E−01 | 4.6361E−01 | −1.9755E−01 | 7.3440E−02 | −2.1558E−02 | 4.0260E−03 | −3.3895E−04 |
| S5 | 5.3561E−01 | −5.0470E−01 | 3.7709E−01 | −2.0217E−01 | 7.1618E−02 | −1.4893E−02 | 1.3711E−03 |
| S6 | 2.3830E−01 | −1.7357E−01 | 9.7664E−02 | −3.8347E−02 | 9.9224E−03 | −1.5417E−03 | 1.1013E−04 |
| S7 | 9.8414E+00 | −6.6389E+00 | 3.2250E+00 | −1.0977E+00 | 2.4837E−01 | −3.3553E−02 | 2.0478E−03 |
| S8 | −2.0162E+00 | 1.3064E+00 | −6.0132E−01 | 1.9229E−01 | −4.0639E−02 | 5.1042E−03 | −2.8849E−04 |
| S9 | 1.6364E−01 | −6.2851E−02 | 1.7399E−02 | −3.3656E−03 | 4.3177E−04 | −3.2941E−05 | 1.1305E−06 |
| S10 | 3.6503E−03 | −8.7316E−04 | 1.4771E−04 | −1.7233E−05 | 1.3178E−06 | −5.9488E−08 | 1.2039E−09 |
| S11 | −4.2681E−04 | 6.6952E−05 | −7.3396E−06 | 5.5878E−07 | −2.8463E−08 | 8.8005E−10 | −1.2561E−11 |
| S12 | −4.3236E−04 | 5.8892E−05 | −5.6119E−06 | 3.6712E−07 | −1.5727E−08 | 3.9777E−10 | −4.5073E−12 |
| S13 | −1.1125E−06 | 1.9315E−07 | −1.5811E−08 | 7.8027E−10 | −2.3710E−11 | 4.1095E−13 | −3.1237E−15 |
| S14 | −3.1168E−07 | 2.2831E−08 | −1.1141E−09 | 3.4916E−11 | −6.4061E−13 | 5.4162E−15 | −5.2881E−18 |

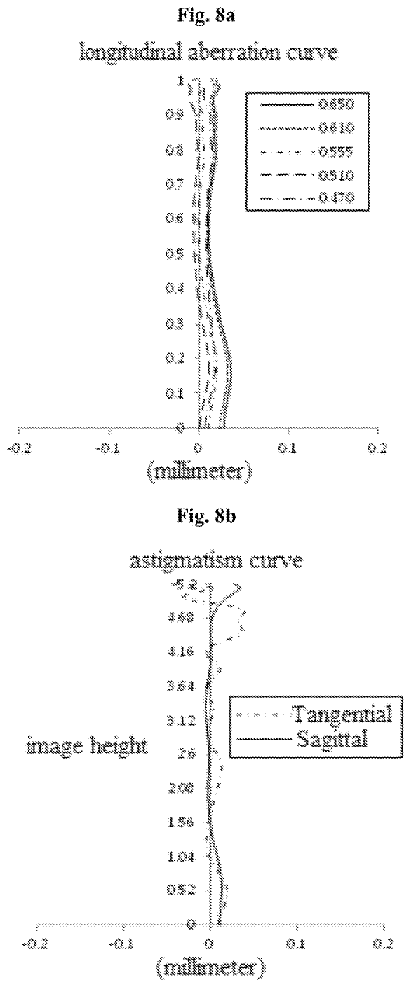

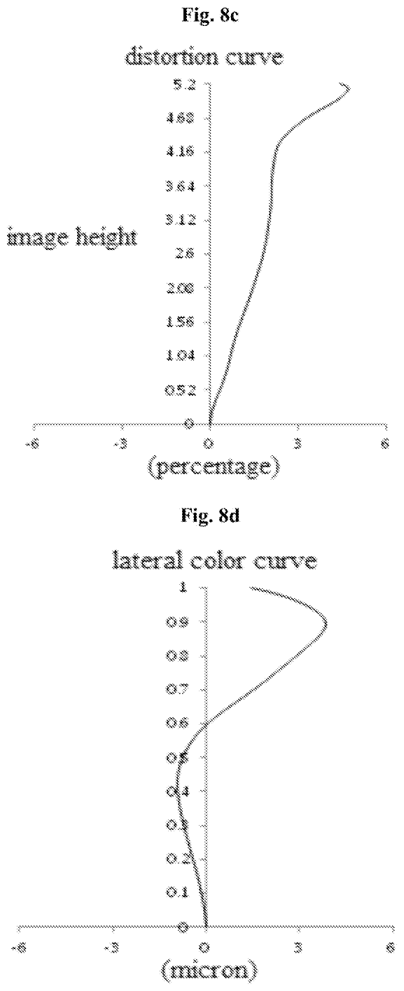

FIG. 8a shows a longitudinal aberration curve of the optical imaging lens assembly according to Embodiment 4 to represent deviations of a convergence focal point after light with different wavelengths passes through the lens assembly. FIG. 8b shows an astigmatism curve of the optical imaging lens assembly according to Embodiment 4 to represent a tangential image surface curvature and a sagittal image surface curvature. FIG. 8c shows a distortion curve of the optical imaging lens assembly according to Embodiment 4 to represent distortion values corresponding to different image heights. FIG. 8d shows a lateral color curve of the optical imaging lens assembly according to Embodiment 4 to represent deviations of different image heights on the imaging surface after the light passes through the lens assembly. According to FIGS. 8a-8d, it can be seen that the optical imaging lens assembly provided in Embodiment 4 may achieve high imaging quality.

### Embodiment 5

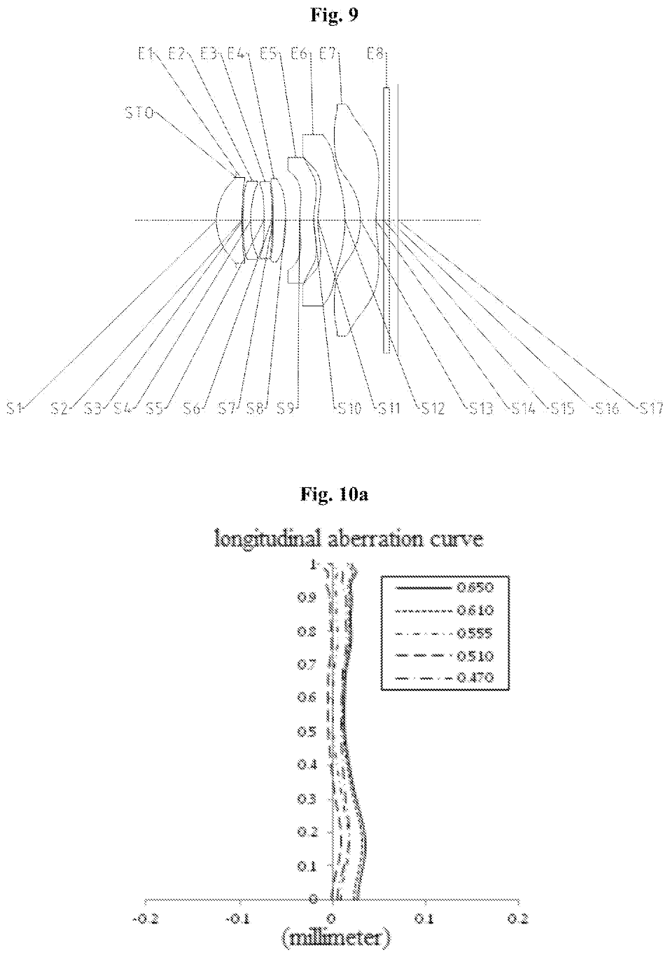

FIG. 9 is a structure diagram of a lens group of an optical imaging lens assembly according to Embodiment 5 of the disclosure. The optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a negative refractive power, an object-side surface S5 thereof is a concave surface, while an image-side surface S6 is a concave surface. The fourth lens E4 has a positive refractive power, an object-side surface S7 thereof is a convex surface, while an image-side surface S8 is a convex surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

Table 13 shows a table of basic parameters for the optical imaging lens assembly of Embodiment 5, and units of the curvature radius, the thickness and the focal length are all millimeter (mm).

TABLE 13

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −0.7220 | | | | |
| S1 | Aspheric | 2.2354 | 0.9304 | 5.07 | 1.54 | 56.1 | −0.0966 |
| S2 | Aspheric | 9.9204 | 0.0340 | | | | 13.3711 |
| S3 | Aspheric | 8.1782 | 0.2902 | −18.40 | 1.67 | 19.2 | −5.0828 |
| S4 | Aspheric | 4.8680 | 0.4825 | | | | −0.4921 |
| S5 | Aspheric | −256.4103 | 0.2860 | −29.82 | 1.67 | 19.2 | 90.0000 |
| S6 | Aspheric | 21.9457 | 0.0413 | | | | 0.0000 |
| S7 | Aspheric | 34.2178 | 0.4533 | 17.79 | 1.54 | 56.1 | 0.0000 |
| S8 | Aspheric | −13.4820 | 0.5169 | | | | 0.0000 |
| S9 | Aspheric | 5.6082 | 0.5102 | −11.10 | 1.57 | 37.3 | −10.9492 |
| S10 | Aspheric | 2.8759 | 0.1568 | | | | −8.1479 |
| S11 | Aspheric | 3.6685 | 0.9833 | 4.08 | 1.54 | 55.7 | −12.6607 |
| S12 | Aspheric | −4.9257 | 0.5597 | | | | −0.9122 |
| S13 | Aspheric | −3.2641 | 0.5688 | −3.38 | 1.54 | 55.7 | −1.0065 |
| S14 | Aspheric | 4.3409 | 0.2787 | | | | −0.1021 |
| S15 | Spherical | Infinite | 0.2100 | | 1.52 | 64.2 | |
| S16 | Spherical | Infinite | 0.3077 | | | | |
| S17 | Spherical | Infinite | | | | | |

As shown in Table 14, in Embodiment 5, a total effective focal length f of the optical imaging lens assembly is 5.42 mm. TTL is a distance from the object-side surface S1 of the first lens E1 to the imaging surface S17 on the optical axis, and TTL is 6.61 mm. ImgH is a half of a diagonal length of an effective pixel region on the imaging surface S17, and ImgH is 5.20 mm. Explanations about parameters of each relational expression are the same as those in Embodiment 1. Numerical values of each relational expression are listed in the following table.

TABLE 14
Embodiment 5

| | | | |
|---|---|---|---|
| f(mm) | 5.42 | f1(mm) | 5.07 |
| TTL(mm) | 6.61 | ImgH(mm) | 5.20 |
| ImgH × ImgH/TTL(mm) | 4.09 | TTL/ImgH | 1.27 |
| f × tan(½FOV)(mm) | 5.00 | f/EPD | 1.65 |
| (RII − R12)/f6 | 2.11 | (f1 − f7)/f | 1.56 |
| f2/(R4 − R3) | 5.56 | (CT1 + CT2)/(CT3 + CT4) | 1.65 |
| (fI2 − f67)/f34 | −0.65 | SAG62/SAG52 | 2.26 |
| SAG71/ET7 | −2.54 | (ET4 + ET5)/ET6 | 1.06 |

In Embodiment 5, both the object-side surface and image-side surface of any lens in the first lens E1 to the seventh lens E7 are aspheric surfaces. Table 15 shows high-order coefficients A₄, A₆, A₈, A₁₀, A₁₂, A₁₄, A₁₆, A₁₈, A₂₀, A₂₂, A₂₄, A₂₆, A₂₈ and A₃₀ that can be used for each of the aspheric mirror surfaces S1-S14 in Embodiment 5.

TABLE 15

| Surface | | | | | | | |
|---|---|---|---|---|---|---|---|
| number | A4 | A6 | A8 | A10 | A12 | A14 | A16 |
| S1 | −3.9432E−04 | 1.5088E−02 | −5.8351E−02 | 1.5787E−01 | −2.8581E−01 | 3.5043E−01 | −2.9210E−01 |
| S2 | −5.0231E−02 | 4.6545E−02 | 7.9533E−02 | −3.7125E−01 | 7.0487E−01 | −8.2321E−01 | 6.2799E−01 |
| S3 | −4.9386E−02 | 6.2039E−02 | 8.9103E−03 | −1.3730E−01 | 2.3828E−01 | −2.9052E−01 | 3.9514E−01 |
| S4 | −6.4379E−03 | 2.3908E−04 | 1.1614E−01 | −4.4691E−01 | 9.7567E−01 | −1.3827E+00 | 1.3352E+00 |
| S5 | −4.2397E−02 | 3.1512E−02 | −1.2698E−01 | 2.7342E−01 | −4.1532E−01 | 4.9507E−01 | −5.2860E−01 |
| S6 | −7.0884E−02 | 1.2746E−01 | −3.0946E−01 | 4.7778E−01 | −5.1847E−01 | 4.3397E−01 | −3.2536E−01 |
| S7 | −7.8735E−02 | 2.2340E−01 | −7.7871E−01 | 2.2538E+00 | −5.1643E+00 | 8.8839E+00 | −1.1264E+01 |
| S8 | −5.8060E−02 | 4.5451E−02 | −1.0159E−03 | −2.6929E−01 | 9.2494E−01 | −1.8091E+00 | 2.3642E+00 |
| S9 | −7.0864E−02 | 6.2824E−02 | −1.4662E−01 | 2.9175E−01 | −4.1772E−01 | 4.2394E−01 | −3.0983E−01 |
| S10 | −6.5998E−02 | 2.7115E−02 | −3.1992E−02 | 3.8335E−02 | −3.4279E−02 | 2.1617E−02 | −9.7569E−03 |
| S11 | −1.8897E−02 | −1.4272E−02 | 1.2574E−02 | −1.2324E−02 | 9.7753E−03 | −5.0907E−03 | 1.7153E−03 |
| S12 | 2.7141E−02 | −2.9063E−02 | 2.8559E−02 | −2.6892E−02 | 1.7608E−02 | −7.4377E−03 | 2.0911E−03 |
| S13 | −3.3429E−02 | 1.1205E−02 | −7.4585E−03 | 3.9078E−03 | −9.7544E−04 | 1.1909E−04 | −3.70484E−06 |
| S14 | −5.1668E−02 | 1.3373E−02 | −2.4503E−03 | 1.6334E−04 | 4.4782E−05 | −1.7571E−05 | 3.0094E−06 |
| Surface | | | | | | | |
| number | A18 | A20 | A22 | A24 | A26 | A28 | A30 |
| S1 | 1.6321E−01 | −5.7820E−02 | 1.0592E−02 | 2.8589E−04 | −6.0287E−04 | 1.2150E−04 | −8.5054E−06 |
| S2 | −3.0610E−01 | 8.2491E−02 | −2.3198E−03 | −6.6211E−03 | 2.3376E−03 | −3.5587E−04 | 2.1397E−05 |
| S3 | −5.4431E−01 | 5.6147E−01 | −3.8887E−01 | 1.7536E−01 | −4.9495E−02 | 7.9530E−03 | −5.5595E−04 |
| S4 | −9.1486E−01 | 4.7170E−01 | −2.0134E−01 | 7.4979E−02 | −2.2048E−02 | 4.1246E−03 | −3.4580E−04 |
| S5 | 5.5091E−01 | −5.2074E−01 | 3.9030E−01 | −2.0991E−01 | 7.4592E−02 | −1.5561E−02 | 1.4370E−03 |
| S6 | 2.5407E−01 | −1.8637E−01 | 1.0562E−01 | −4.1767E−02 | 1.0884E−02 | −1.7033E−03 | 1.2254E−04 |
| S7 | 1.0484E+01 | −7.1219E+00 | 3.4841E+00 | −1.1942E+00 | 2.7211E−01 | 3.7020E−02 | 2.2753E−03 |
| S8 | −2.1688E+00 | 1.4152E+00 | −6.5663E−01 | 2.1167E−01 | −4.5093E−02 | 5.7092E−03 | −3.2527E−04 |
| S9 | 1.6457E−01 | −6.3509E−02 | 1.7600E−02 | −3.4090E−03 | 4.3765E−04 | −3.3424E−05 | 1.1483E−06 |
| S10 | 3.1847E−03 | −7.4829E−04 | 1.2465E−04 | −1.4320E−06 | 1.0782E−06 | −4.7929E−08 | 9.5515E−10 |
| S11 | −3.8638E−04 | 5.9945E−05 | −8.4991E−06 | 4.8935E−07 | −2.4653E−08 | 7.5385E−10 | −1.6641E−11 |
| S12 | −4.0425E−04 | 5.4653E−05 | −5.1692E−08 | 3.3564E−07 | −1.4272E−08 | 3.5827E−10 | −4.0295E−12 |
| S13 | −9.8331E−07 | 1.6840E−07 | −1.3597E−08 | 6.6186E−10 | −1.9838E−11 | 3.3915E−13 | −2.5428E−15 |
| S14 | −3.2482E−07 | 2.3362E−08 | −1.1167E−09 | 3.4003E−11 | −5.9296E−13 | 4.3628E−15 | 3.8148E−18 |

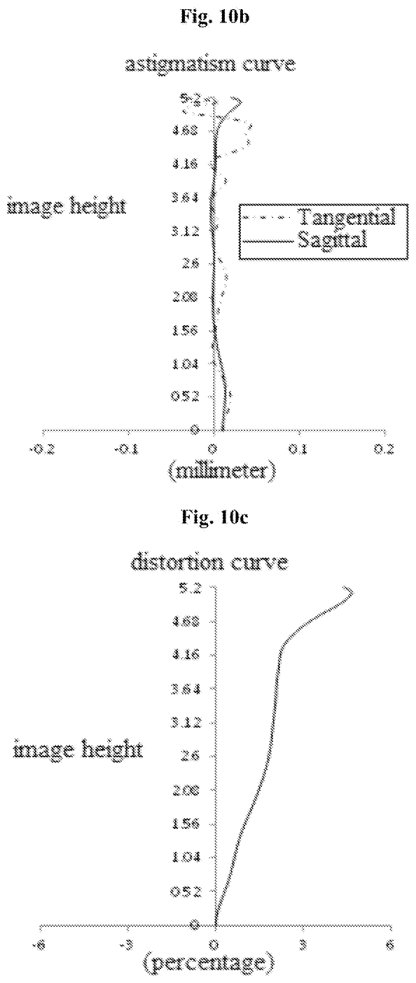

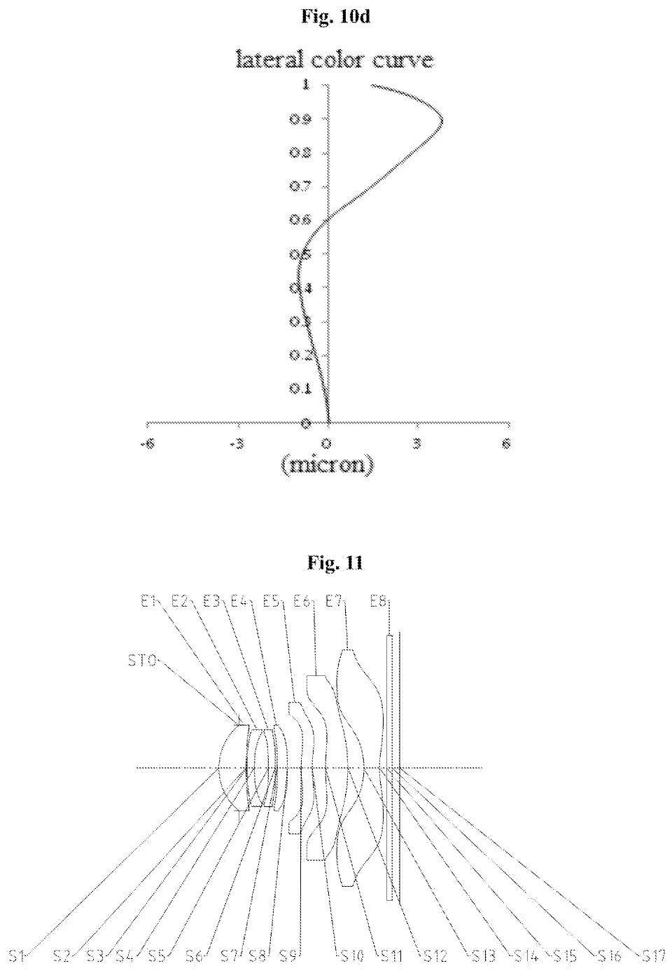

FIG. 10a shows a longitudinal aberration curve of the optical imaging lens assembly according to Embodiment 5 to represent deviations of a convergence focal point after light with different wavelengths passes through the lens assembly. FIG. 10b shows an astigmatism curve of the optical imaging lens assembly according to Embodiment 5 to represent a tangential image surface curvature and a sagittal image surface curvature. FIG. 10c shows a distortion curve of the optical imaging lens assembly according to Embodiment 5 to represent distortion values corresponding to different image heights. FIG. 10d shows a lateral color curve of the optical imaging lens assembly according to Embodiment 5 to represent deviations of different image heights on the imaging surface after the light passes through the lens assembly. According to FIGS. 10a-10d, it can be seen that the optical imaging lens assembly provided in Embodiment 5 may achieve high imaging quality.

### Embodiment 6

FIG. 11 is a structure diagram of a lens group of an optical imaging lens assembly according to Embodiment 6 of the disclosure. The optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a negative refractive power, an object-side surface S5 thereof is a concave surface, while an image-side surface S6 is a convex surface. The fourth lens E4 has a positive refractive power, an object-side surface S7 thereof is a concave surface, while an image-side surface S8 is a convex surface. The fifth lens E5 has a positive refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

Table 16 shows a table of basic parameters for the optical imaging lens assembly of Embodiment 6, and units of the curvature radius, the thickness and the focal length are all millimeter (mm).

TABLE 16

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −0.7300 | | | | |
| S1 | Aspheric | 2.2369 | 0.9921 | 5.25 | 1.54 | 56.1 | −0.0541 |
| S2 | Aspheric | 8.6354 | 0.0342 | | | | 0.4993 |
| S3 | Aspheric | 6.8504 | 0.2599 | −17.79 | 1.67 | 19.2 | −0.1557 |
| S4 | Aspheric | 4.3010 | 0.5170 | | | | 3.1767 |
| S5 | Aspheric | −32.9068 | 0.2543 | −53.32 | 1.67 | 19.2 | 90.0000 |
| S6 | Aspheric | −370.3704 | 0.0677 | | | | 0.0000 |
| S7 | Aspheric | −85.3314 | 0.3800 | 27.76 | 1.54 | 56.1 | 0.0000 |
| S8 | Aspheric | −12.8826 | 0.4910 | | | | 0.0000 |
| S9 | Aspheric | 4.3493 | 0.4104 | 114.87 | 1.57 | 37.3 | −8.0637 |
| S10 | Aspheric | 4.4989 | 0.4808 | | | | −6.9874 |
| S11 | Aspheric | 7.4888 | 0.8173 | 6.12 | 1.54 | 55.7 | −4.3059 |
| S12 | Aspheric | −5.6351 | 0.5834 | | | | −0.5814 |
| S13 | Aspheric | −3.2492 | 0.5749 | −3.43 | 1.54 | 55.7 | −1.2143 |
| S14 | Aspheric | 4.4972 | 0.2484 | | | | −0.0641 |
| S15 | Spherical | Infinite | 0.2100 | | 1.52 | 64.2 | |
| S16 | Spherical | Infinite | 0.2685 | | | | |
| S17 | Spherical | Infinite | | | | | |

As shown in Table 17, in Embodiment 6, a total effective focal length f of the optical imaging lens assembly is 5.42 mm. TTL is a distance from the object-side surface S1 of the first lens E1 to the imaging surface S17 on the optical axis, and TTL is 6.59 mm. ImgH is a half of a diagonal length of an effective pixel region on the imaging surface S17, and ImgH is 5.20 mm. Explanations about parameters of each relational expression are the same as those in Embodiment 1. Numerical values of each relational expression are listed in the following table.

TABLE 17
Embodiment 6

| | | | |
|---|---|---|---|
| f(mm) | 5.42 | f1(mm) | 5.25 |
| TTL(mm) | 6.59 | ImgH(mm) | 5.20 |
| ImgH × ImgH/TTL(mm) | 4.10 | TTL/ImgH | 1.27 |
| f × tan(½FOV)(mm) | 5.01 | f/EPD | 1.65 |
| (RII − R12)/f6 | 2.14 | (f1 − f7)/f | 1.60 |
| f2/(R4 − R3) | 6.98 | (CT1 + CT2)/(CT3 + CT4) | 1.97 |
| (fI2 − f67)/f34 | 0.33 | SAG62/SAG52 | 1.82 |
| SAG71/ET7 | −2.12 | (ET4 + ET5)/ET6 | 0.82 |

In Embodiment 6, both the object-side surface and image-side surface of any lens in the first lens E1 to the seventh lens E7 are aspheric surfaces. Table 18 shows high-order coefficients A₄, A₆, A₈, A₁₀, A₁₂, A₁₄, A₁₆, A₁₈, A₂₀, A₂₂, A₂₄, A₂₆, A₂₈ and A₃₀ that can be used for each of the aspheric mirror surfaces S1-S14 in Embodiment 6.

TABLE 18

| Surface | | | | | | | |
|---|---|---|---|---|---|---|---|
| number | A4 | A6 | A8 | A10 | A12 | A14 | A16 |
| S1 | −3.3820E−04 | 1.1878E−02 | −4.2416E−02 | 1.0596E−01 | −1.7713E−01 | 2.0054E−01 | −1.5434E−01 |
| S2 | −4.5960E−02 | 4.0737E−02 | 6.6585E−02 | −2.9730E−01 | 5.3994E−01 | −6.0320E−01 | 4.4015E−01 |
| S3 | −4.6643E−02 | 5.6944E−02 | 7.9482E−03 | −1.1993E−01 | 2.0075E−01 | −2.3787E−01 | 3.1442E−01 |
| S4 | −6.6421E−03 | 2.5054E−04 | 1.2362E−01 | −4.8320E−01 | 1.0715E+00 | −1.5424E+00 | 1.5140E+00 |
| S5 | −3.7839E−02 | 2.6360E−02 | −1.0008E−01 | 2.0305E−01 | −2.9061E−01 | 3.2640E−01 | −3.2837E−01 |
| S6 | −6.1542E−02 | 1.0311E−01 | −2.3326E−01 | 3.3557E−01 | −3.3930E−01 | 2.6463E−01 | −1.8486E−01 |
| S7 | −6.4595E−02 | 1.6601E−01 | −5.2413E−01 | 1.3710E+00 | −2.8516E+00 | 4.4433E+00 | −5.1029E+00 |
| S8 | −5.0947E−02 | 3.7360E−02 | −7.8227E−04 | −1.9424E−01 | 6.2496E−01 | −1.1450E+00 | 1.4017E+00 |
| S9 | −6.2549E−02 | 5.2097E−02 | −1.1422E−01 | 2.1354E−01 | −2.8725E−01 | 2.7389E−01 | −1.8805E−01 |
| S10 | −5.9421E−02 | 2.3164E−02 | −2.5833E−02 | 2.9486E−02 | −2.5018E−02 | 1.4970E−02 | −6.4113E−03 |
| S11 | −1.4191E−02 | −9.2881E−03 | 7.0916E−03 | −6.0232E−03 | 4.1402E−03 | −1.8684E−03 | 5.4558E−04 |
| S12 | 2.1894E−02 | −2.1058E−02 | 1.8585E−02 | −1.5718E−02 | 9.2438E−03 | −3.5070E−03 | 8.8559E−04 |
| S13 | −2.9120E−02 | 9.1101E−03 | −5.6597E−03 | 2.7677E−03 | −6.4479E−04 | 7.3475E−05 | −2.1584E−06 |
| S14 | −3.6589E−02 | 4.1294E−03 | 1.2390E−03 | −1.0152E−03 | 3.3973E−04 | −7.3133E−05 | 1.0861E−05 |
| Surface | | | | | | | |
| number | A18 | A20 | A22 | A24 | A26 | A28 | A30 |
| S1 | 7.9628E−02 | −2.6048E−02 | 4.4081E−03 | 1.0981E−04 | −2.1381E−04 | 8.9789E−05 | −2.5718E−06 |
| S2 | −2.0522E−01 | 5.2902E−02 | −1.4231E−03 | −3.8851E−03 | 1.3121E−03 | −1.9096E−04 | 1.0989E−05 |
| S3 | −4.2092E−01 | 4.2197E−01 | −2.8402E−01 | 1.2447E−01 | −3.4142E−02 | 5.3317E−03 | −3.6221E−04 |
| S4 | −1.0529E+00 | 5.5142E−01 | −2.3907E−01 | 9.0432E−02 | −2.7010E−02 | 5.1324E−03 | −4.3707E−04 |
| S5 | 3.2245E−01 | −2.5719E−01 | 2.0282E−01 | −1.0278E−01 | 3.4412E−02 | −6.7639E−03 | 5.8854E−04 |
| S6 | 1.3451E−01 | −9.1938E−02 | 4.8547E−02 | −1.7888E−02 | 4.3436E−03 | −6.3334E−04 | 4.2456E−05 |
| S7 | 4.3017E+00 | −2.6469E+00 | 1.1729E+00 | −3.6413E−01 | 7.5150E−02 | −9.2605E−03 | 5.1553E−04 |
| S8 | −1.2034E+00 | 7.3630E−01 | −3.2002E−01 | 9.6638E−02 | −1.9285E−02 | 2.2872E−03 | −1.2207E−04 |
| S9 | 9.3847E−02 | −3.4024E−02 | 8.8584E−03 | −1.6120E−03 | 1.9443E−04 | −1.3951E−05 | 4.5028E−07 |
| S10 | 1.9857E−03 | −4.4271E−04 | 6.9974E−05 | −7.6278E−06 | 5.4497E−07 | −2.2986E−08 | 4.3468E−10 |
| S11 | −1.0850E−04 | 1.4319E−05 | −1.3453E−06 | 8.7780E−08 | −3.8323E−09 | 1.0155E−10 | −1.2423E−12 |
| S12 | −1.5376E−04 | 1.8671E−05 | −1.5861E−06 | 9.2500E−08 | −3.5326E−09 | 7.9651E−11 | −8.0461E−13 |
| S13 | −5.2847E−07 | 8.4470E−08 | −6.3655E−09 | 2.8920E−10 | −8.0903E−12 | 1.2909E−13 | −9.0336E−16 |
| S14 | −1.1425E−06 | 8.5954E−08 | −4.6013E−09 | 1.7133E−10 | −4.2202E−12 | 6.1856E−14 | −4.0864E−16 |

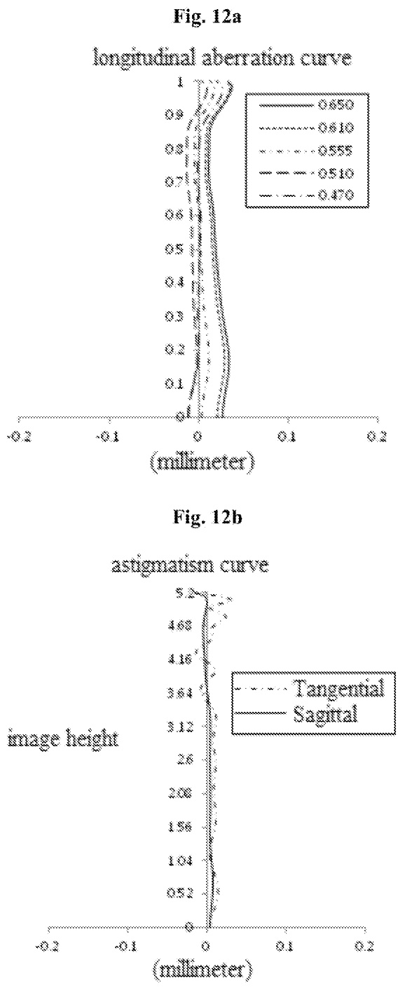

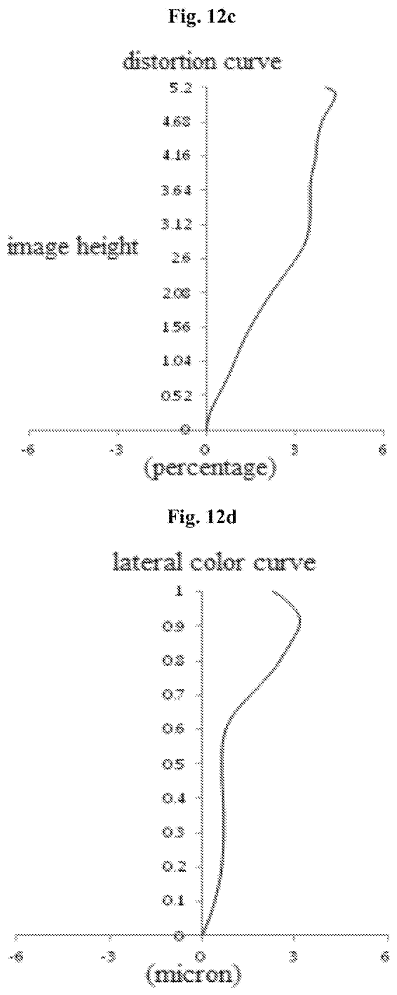

FIG. 12a shows a longitudinal aberration curve of the optical imaging lens assembly according to Embodiment 6 to represent deviations of a convergence focal point after light with different wavelengths passes through the lens assembly. FIG. 12b shows an astigmatism curve of the optical imaging lens assembly according to Embodiment 6 to represent a tangential image surface curvature and a sagittal image surface curvature. FIG. 12c shows a distortion curve of the optical imaging lens assembly according to Embodiment 6 to represent distortion values corresponding to different image heights. FIG. 12d shows a lateral color curve of the optical imaging lens assembly according to Embodiment 6 to represent deviations of different image heights on the imaging surface after the light passes through the lens assembly. According to FIGS. 12a-12d, it can be seen that the optical imaging lens assembly provided in Embodiment 6 may achieve high imaging quality.

### Embodiment 7

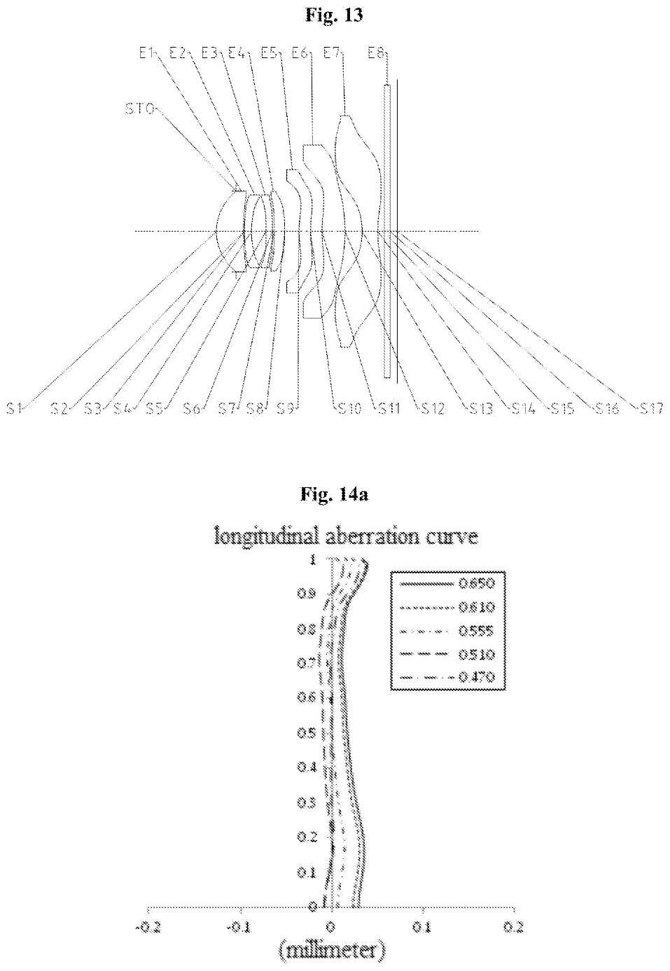

FIG. 13 is a structure diagram of a lens group of an optical imaging lens assembly according to Embodiment 7 of the disclosure. The optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a negative refractive power, an object-side surface S5 thereof is a concave surface, while an image-side surface S6 is a convex surface. The fourth lens E4 has a positive refractive power, an object-side surface S7 thereof is a concave surface, while an image-side surface S8 is a convex surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

Table 19 shows a table of basic parameters for the optical imaging lens assembly of Embodiment 7, and units of the curvature radius, the thickness and the focal length are all millimeter (mm).

TABLE 19

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −0.7200 | | | | |
| S1 | Aspheric | 2.2415 | 0.9871 | 5.24 | 1.54 | 56.1 | −0.0522 |
| S2 | Aspheric | 8.7638 | 0.0340 | | | | 1.0146 |
| S3 | Aspheric | 7.0647 | 0.2583 | −18.05 | 1.67 | 19.2 | 0.2319 |
| S4 | Aspheric | 4.4117 | 0.5221 | | | | 3.4391 |
| S5 | Aspheric | −33.4712 | 0.2398 | −54.32 | 1.67 | 19.2 | 90.0000 |
| S6 | Aspheric | −370.3704 | 0.0680 | | | | 0.0000 |
| S7 | Aspheric | −52.1052 | 0.3800 | 27.28 | 1.54 | 56.1 | 0.0000 |
| S8 | Aspheric | −11.6043 | 0.5220 | | | | 0.0000 |
| S9 | Aspheric | 4.3084 | 0.4149 | −129.81 | 1.57 | 37.3 | −11.1222 |
| S10 | Aspheric | 3.9291 | 0.4214 | | | | −10.7588 |
| S11 | Aspheric | 5.8934 | 0.8426 | 5.88 | 1.54 | 55.7 | −12.6195 |
| S12 | Aspheric | −6.4522 | 0.6226 | | | | 1.0353 |
| S13 | Aspheric | −3.3019 | 0.5665 | −3.49 | 1.54 | 55.7 | 1.1909 |
| S14 | Aspheric | 4.5921 | 0.2403 | | | | −0.0692 |
| S15 | Spherical | Infinite | 0.2100 | | 1.52 | 64.2 | |
| S16 | Spherical | Infinite | 0.2604 | | | | |

| | | |
|---|---|---|
| S17 | Spherical | Infinite |

As shown in Table 20, in Embodiment 7, a total effective focal length f of the optical imaging lens assembly is 5.43 mm. TTL is a distance from the object-side surface S1 of the first lens E1 to the imaging surface S17 on the optical axis, and TTL is 6.59 mm. ImgH is a half of a diagonal length of an effective pixel region on the imaging surface S17, and ImgH is 5.20 mm. Explanations about parameters of each relational expression are the same as those in Embodiment 1. Numerical values of each relational expression are listed in the following table.

TABLE 20
Embodiment 7

| | | | |
|---|---|---|---|
| f(mm) | 5.43 | f1(mm) | 5.24 |
| TTL(mm) | 6.59 | ImgH(mm) | 5.20 |
| ImgH × ImgH/TTL(mm) | 4.10 | TTL/ImgH | 1.27 |
| f × tan(½FOV)(mm) | 5.01 | f/EPD | 1.65 |
| (RII − R12)/f6 | 2.10 | (f1 − f7)/f | 1.61 |
| f2/(R4 − R3) | 6.80 | (CT1 + CT2)/(CT3 + CT4) | 2.01 |
| (fI2 − f67)/f34 | 0.41 | SAG62/SAG52 | 1.84 |
| SAG71/ET7 | −2.43 | (ET4 + ET5)/ET6 | 0.84 |

In Embodiment 7, both the object-side surface and image-side surface of any lens in the first lens E1 to the seventh lens E7 are aspheric surfaces. Table 21 shows high-order coefficients A₄, A₆, A₈, A₁₀, A₁₂, A₁₄, A₁₆, A₁₈, A₂₀, A₂₂, A₂₄, A₂₆, A₂₈ and A₃₀ that can be used for each of the aspheric mirror surfaces S1-S14 in Embodiment 7.

TABLE 21

| Surface | | | | | | | |
|---|---|---|---|---|---|---|---|
| number | A4 | A6 | A8 | A10 | A12 | A14 | A16 |
| S1 | −3.4285E−04 | 1.2222E−02 | −4.4061E−02 | 1.1112E−01 | −1.8753E−01 | 2.1434E−01 | −1.6655E−01 |
| S2 | −4.6483E−02 | 4.1434E−02 | 6.8108E−02 | −3.0582E−01 | 5.5857E−01 | −6.2754E−01 | 4.6052E−01 |
| S3 | −4.6918E−02 | 5.7448E−02 | 8.0421E−03 | −1.2079E−01 | 2.0431E−01 | −2.4281E−01 | 3.2189E−01 |
| S4 | −6.5798E−03 | 2.4702E−04 | 1.2131E−01 | −4.7194E−01 | 1.0416E+00 | −1.4923E+00 | 1.4580E+00 |
| S5 | −3.8992E−02 | 2.7794E−02 | −1.0740E−01 | 2.2179E−01 | −3.2309E−01 | 3.6934E−01 | −3.7819E−01 |
| S6 | −6.3354E−02 | 1.0770E−01 | −2.4721E−01 | 3.6083E−01 | −3.7017E−01 | 2.9292E−01 | −2.0762E−01 |
| S7 | −6.7092E−02 | 1.7573E−01 | −5.6543E−01 | 1.5107E+00 | −3.1953E+00 | 5.0741E+00 | −5.9389E+00 |
| S8 | −5.2182E−02 | 3.8727E−02 | −8.2064E−04 | −2.0622E−01 | 6.7151E−01 | −1.2451E+00 | 1.5427E+00 |
| S9 | −6.1593E−02 | 5.0907E−02 | −1.1076E−01 | 2.0548E−01 | −2.7428E−01 | 2.5951E−01 | −1.7682E−01 |
| S10 | −5.8969E−02 | 2.2901E−02 | −2.5541E−02 | 2.8929E−02 | −2.4453E−02 | 1.4576E−02 | −6.2188E−03 |
| S11 | −1.3771E−02 | −8.8785E−03 | 5.6777E−03 | −5.5870E−03 | 3.7830E−03 | −1.6818E−03 | 4.8375E−04 |
| S12 | 2.1731E−02 | −2.0823E−02 | 1.8309E−02 | −1.5428E−02 | 9.0389E−03 | −3.4164E−03 | 8.5951E−04 |
| S13 | −2.8744E−02 | 8.9343E−03 | −5.5146E−03 | 2.6792E−03 | −6.2014E−04 | 7.0210E−05 | −2.0491E−06 |
| S14 | −3.6865E−02 | 4.8320E−03 | 7.1245E−04 | −7.0782E−04 | 2.4089E−04 | −5.1166E−05 | 7.3998E−06 |
| Surface | | | | | | | |
| number | A18 | A20 | A22 | A24 | A26 | A28 | A30 |
| S1 | 8.6743E−02 | −2.8647E−02 | 4.8919E−03 | 1.2308E−04 | −2.4195E−04 | 4.5455E−05 | −2.9861E−06 |
| S2 | −2.1593E−01 | 5.5979E−02 | −1.5144E−03 | −4.1578E−03 | 1.4121E−03 | −2.0669E−04 | 1.1961E−05 |
| S3 | −4.3219E−01 | 4.3454E−01 | −2.9334E−01 | 1.2893E−01 | −3.5470E−02 | 5.5553E−03 | −3.7851E−04 |
| S4 | −1.0092E+00 | 5.2602E−01 | −2.2699E−01 | 8.5456E−02 | −2.5404E−02 | 4.8045E−03 | −4.0722E−04 |
| S5 | 3.7800E−01 | −3.4265E−01 | 2.4629E−01 | −1.2703E−01 | 4.3291E−02 | −8.6506E−03 | 7.6700E−04 |
| S6 | 1.5328E−01 | −1.0630E−01 | 5.6950E−02 | −2.1291E−02 | 5.2455E−03 | −7.7802E−04 | 5.2781E−05 |
| S7 | 5.1023E+00 | −3.1996E+00 | 1.4449E+00 | −4.5718E−01 | 9.6162E−02 | −1.2077E−02 | 6.8517E−04 |
| S8 | −1.3404E+00 | 8.2996E−01 | −3.6508E−01 | 1.1157E−01 | −2.2533E−02 | 2.7046E−03 | −1.4608E−04 |
| S9 | 8.7562E−02 | −3.1502E−02 | 8.1389E−03 | −1.4697E−03 | 1.7591E−04 | −1.2525E−05 | 4.0116E−07 |
| S10 | 1.9188E−03 | −4.2616E−04 | 6.7101E−05 | −7.2868E−06 | 5.1863E−07 | −2.1792E−08 | 4.1060E−10 |
| S11 | −9.3022E−05 | 1.2320E−05 | −1.1462E−06 | 7.3290E−08 | −3.1519E−09 | 8.2277E−11 | −9.9144E−13 |
| S12 | −1.4868E−04 | 1.7987E−05 | −1.5223E−06 | 8.8444E−08 | −3.3652E−09 | 7.5592E−11 | −7.6076E−13 |
| S13 | −4.9846E−07 | 7.9158E−08 | −5.9266E−09 | 2.6752E−10 | −7.4352E−12 | 1.1787E−13 | −8.1950E−16 |
| S14 | −7.4981E−07 | 5.3862E−08 | −2.7343E−09 | 9.6038E−11 | −2.2222E−12 | 3.0488E−14 | −1.8795E−16 |

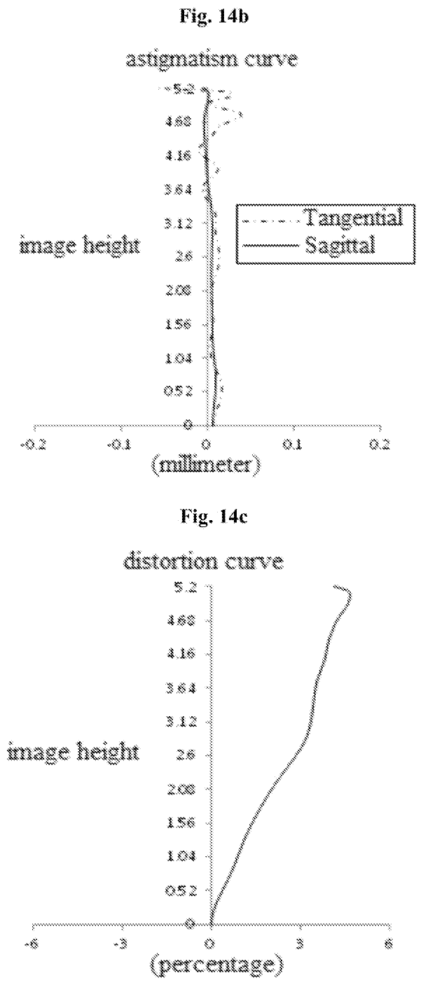

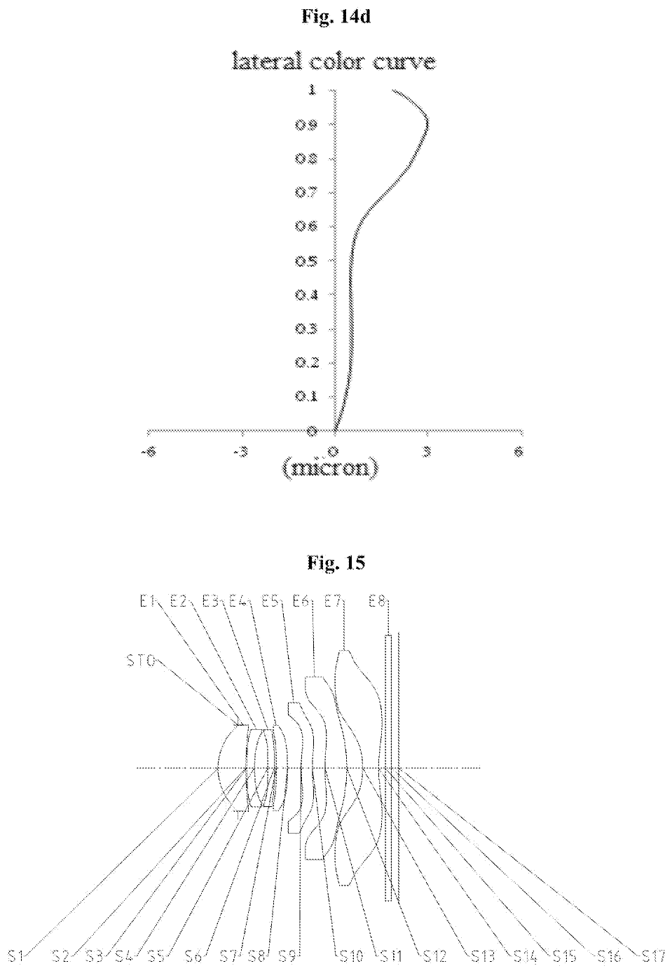

FIG. 14a shows a longitudinal aberration curve of the optical imaging lens assembly according to Embodiment 7 to represent deviations of a convergence focal point after light with different wavelengths passes through the lens assembly. FIG. 14b shows an astigmatism curve of the optical imaging lens assembly according to Embodiment 7 to represent a tangential image surface curvature and a sagittal image surface curvature. FIG. 14c shows a distortion curve of the optical imaging lens assembly according to Embodiment 7 to represent distortion values corresponding to different image heights. FIG. 14d shows a lateral color curve of the optical imaging lens assembly according to Embodiment 7 to represent deviations of different image heights on the imaging surface after the light passes through the lens assembly. According to FIGS. 14a-14d, it can be seen that the optical imaging lens assembly provided in Embodiment 7 may achieve high imaging quality.

### Embodiment 8

FIG. 15 is a structure diagram of a lens group of an optical imaging lens assembly according to Embodiment 8 of the disclosure. The optical imaging lens assembly sequentially includes, from an object side to an image side along an optical axis, a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a negative refractive power, an object-side surface S5 thereof is a concave surface, while an image-side surface S6 is a concave surface. The fourth lens E4 has a positive refractive power, an object-side surface S7 thereof is a concave surface, while an image-side surface S8 is a convex surface. The fifth lens E5 has a positive refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16, and is finally imaged on the imaging surface S17.

Table 22 shows a table of basic parameters for the optical imaging lens assembly of Embodiment 8, and units of the curvature radius, the thickness and the focal length are all millimeter (mm).

TABLE 22

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinite | Infinite | | | | |
| STO | Spherical | Infinite | −0.7280 | | | | |
| S1 | Aspheric | 2.2373 | 1.0109 | 5.15 | 1.54, | 56.1 | −0.0682 |
| S2 | Aspheric | 9.2397 | 0.0340 | | | | 3.5465 |
| S3 | Aspheric | 7.8313 | 0.2785 | −16.73 | 1.67 | 19.2 | 0.3449 |
| S4 | Aspheric | 4.5651 | 0.4880 | | | | 3.0987 |
| S5 | Aspheric | −174.9439 | 0.2375 | −55.65 | 1.67 | 19.2 | 90.0000 |
| S6 | Aspheric | 48.0896 | 0.0707 | | | | 0.0000 |
| S7 | Aspheric | −125.0000 | 0.4113 | 28.99 | 1.54 | 56.1 | 0.0000 |
| S8 | Aspheric | −14.0558 | 0.4931 | | | | 0.0000 |
| S9 | Aspheric | 4.7140 | 0.4108 | 128.61 | 1.57 | 37.3 | −6.1419 |
| S10 | Aspheric | 4.8783 | 0.4621 | | | | −5.4430 |
| S11 | Aspheric | 7.3087 | 0.7940 | 6.02 | 1.54 | 55.7 | −6.6978 |
| S12 | Aspheric | −5.5667 | 0.5804 | | | | −0.2177 |
| S13 | Aspheric | −3.1828 | 0.5737 | −3.38 | 1.54 | 55.7 | −1.1407 |
| S14 | Aspheric | 4.4823 | 0.2525 | | | | −0.0623 |
| S15 | Spherical | Infinite | 0.2100 | | 1.52 | 64.2 | |
| S16 | Spherical | Infinite | 0.2725 | | | | |
| S17 | Spherical | Infinite | | | | | |

As shown in Table 23, in Embodiment 8, a total effective focal length f of the optical imaging lens assembly is 5.43 mm. TTL is a distance from the object-side surface S1 of the first lens E1 to the imaging surface S17 on the optical axis, and TTL is 6.58 mm. ImgH is a half of a diagonal length of an effective pixel region on the imaging surface S17, and ImgH is 5.20 mm. Explanations about parameters of each relational expression are the same as those in Embodiment 1. Numerical values of each relational expression are listed in the following table.

TABLE 23
Embodiment 8

| | | | |
|---|---|---|---|
| f(mm) | 5.43 | f1(mm) | 5.15 |
| TTL(mm) | 6.58 | ImgH(mm) | 5.20 |
| ImgH × ImgH/TTL(mm) | 4.11 | TTL/ImgH | 1.27 |
| f × tan(½FOV)(mm) | 4.99 | f/EPD | 1.65 |
| (RII − R12)/f6 | 2.14 | (f1 − f7)/f | 1.57 |
| f2/(R4 − R3) | 5.12 | (CT1 + CT2)/(CT3 + CT4) | 1.99 |
| (fI2 − f67)/f34 | 0.32 | SAG62/SAG52 | 1.80 |
| SAG71/ET7 | −2.48 | (ET4 + ET5)/ET6 | 0.93 |

In Embodiment 8, both the object-side surface and image-side surface of any lens in the first lens E1 to the seventh lens E7 are aspheric surfaces. Table 24 shows high-order coefficients A₄, A₆, A₈, A₁₀, A₁₂, A₁₄, A₁₆, A₁₈, A₂₀, A₂₂, A₂₄, A₂₆, A₂₈ and A₃₀ that can be used for each of the aspheric mirror surfaces S1-S14 in Embodiment 8.

TABLE 24

| Surface | | | | | | | |
|---|---|---|---|---|---|---|---|
| number | A4 | A6 | A8 | A10 | A12 | A14 | A16 |
| S1 | −3.4663E−04 | 1.2435E−02 | −4.5089E−02 | 1.1437E−01 | −1.9413E−01 | 2.2317E−01 | −1.7441E−01 |
| S2 | −4.6285E−02 | 4.1169E−02 | 6.7528E−02 | −3.0258E−01 | 5.5146E−01 | −6.1824E−01 | 4.5272E−01 |
| S3 | −4.6374E−02 | 5.6451E−02 | 7.8566E−03 | −1.1732E−01 | 1.9729E−01 | −2.3310E−01 | 3.0722E−01 |
| S4 | −6.6224E−03 | 2.4943E−04 | 1.2289E−01 | −4.7963E−01 | 1.0620E+00 | −1.5264E+00 | 1.4961E+00 |
| S5 | −3.8821E−02 | 2.7611E−02 | −1.0646E−01 | 2.1936E−01 | −3.1885E−01 | 3.8369E−01 | −3.7159E−01 |
| S6 | −6.3845E−02 | 1.0895E−01 | −2.5105E−01 | 3.678E−01 | −3.7883E−01 | 3.0093E−01 | 2.1412E−01 |
| S7 | −6.9499E−02 | 1.8527E−01 | −6.0674E−01 | 1.6499E+00 | −3.5517E+00 | 5.7404E+00 | −6.8383E+00 |
| S8 | −5.1770E−02 | 3.8269E−02 | −8.0772E−04 | −2.0217E−01 | 6.5572E−01 | −1.2110E+00 | 1.4945E+00 |
| S9 | −6.7501E−02 | 5.8405E−02 | −1.3303E−01 | 2.5835E−01 | −3.6102E−01 | 3.5760E−01 | −2.5506E−01 |
| S10 | −6.4143E−02 | 2.5979E−02 | −3.0219E−02 | 3.5697E−02 | −3.1469E−02 | 1.9564E−02 | −8.7053E−03 |
| S11 | −1.4463E−02 | −9.5557E−03 | 7.3653E−03 | −6.3151E−03 | 4.3821E−03 | −1.9965E−03 | 5.8851E−04 |
| S12 | 2.2764E−02 | −2.2325E−02 | 2.0091E−02 | −1.7327E−02 | 1.0390E−02 | −4.0194E−03 | 1.0349E−03 |
| S13 | −3.0560E−02 | 9.7944E−03 | −6.2335E−03 | 3.1227E−03 | −7.4528E−04 | 8.7002E−05 | −2.6182E−06 |
| S14 | −3.8276E−02 | 4.8177E−03 | 1.0757E−03 | −9.2957E−04 | 3.1526E−04 | −6.7791E−05 | 1.0014E−05 |
| Surface | | | | | | | |
| number | A18 | A20 | A22 | A24 | A26 | A28 | A30 |
| S1 | 9.1366E−02 | −3.0348E−02 | 5.2125E−03 | 1.3191E−04 | −2.6079E−04 | 4.9279E−05 | −3.2342E−05 |
| S2 | −2.1182E−01 | 5.4797E−02 | −1.4792E−03 | −4.0527E−03 | 1.3735E−03 | −2.0060E−04 | 1.1584E−05 |
| S3 | −4.1008E−01 | 4.0992E−01 | −2.7511E−01 | 1.2022E−01 | −3.2880E−02 | 5.1197E−03 | −3.4680E−04 |
| S4 | −1.0389E+00 | 5.4329E−01 | −2.3520E−01 | 8.5834E−02 | −2.6494E−02 | 5.0268E−03 | −4.2744E−04 |
| S5 | 3.7058E−01 | −3.3519E−01 | 2.4040E−01 | −1.2372E−01 | 4.2069E−02 | −8.3976E−03 | 7.4207E−04 |
| S6 | 1.5869E−01 | −1.1047E−01 | 5.9416E−02 | −2.2299E−02 | 5.5160E−03 | −8.1904E−04 | 5.5922E−05 |
| S7 | 5.9794E+00 | −3.8164E+00 | 1.7541E+00 | −5.6486E−01 | 1.2092E−01 | −1.5456E−02 | 8.9252E−04 |
| S8 | −1.2934E+00 | 7.9767E−01 | −3.4948E−01 | 1.0638E−01 | −2.1400E−02 | 2.5585E−03 | −1.3764E−04 |
| S9 | 1.3223E−01 | −4.9802E−02 | 1.3470E−02 | −2.5463E−03 | 3.1905E−04 | −2.3781E−05 | 7.9738E−07 |
| S10 | 2.8013E−03 | −6.4888E−04 | 1.0658E−04 | −1.2089E−05 | 8.9685E−07 | −3.9258E−08 | 7.7128E−10 |
| S11 | −1.1597E−04 | 1.5740E−05 | −1.4929E−06 | 9.8341E−08 | −4.3341E−09 | 1.1594E−10 | −1.4318E−12 |
| S12 | −1.8323E−04 | 2.2687E−05 | −1.9652E−06 | 1.1686E−07 | −4.5508E−09 | 1.0463E−10 | −1.0777E−12 |
| S13 | −6.5671E−07 | 1.0753E−07 | −8.3015E−09 | 3.8638E−10 | −1.1073E−11 | 1.8100E−13 | −1.2975E−15 |
| S14 | −1.0463E−06 | 7.8172E−08 | −4.1572E−09 | 1.5385E−10 | −3.7690E−12 | 5.4971E−14 | −3.6157E−16 |

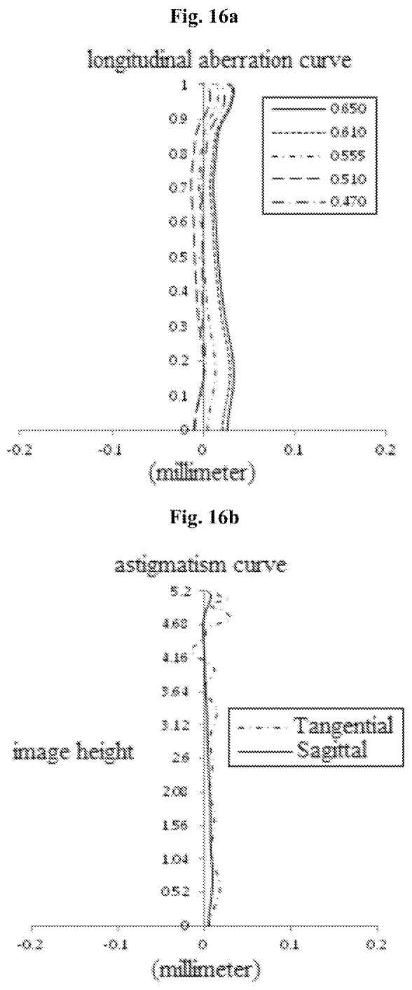

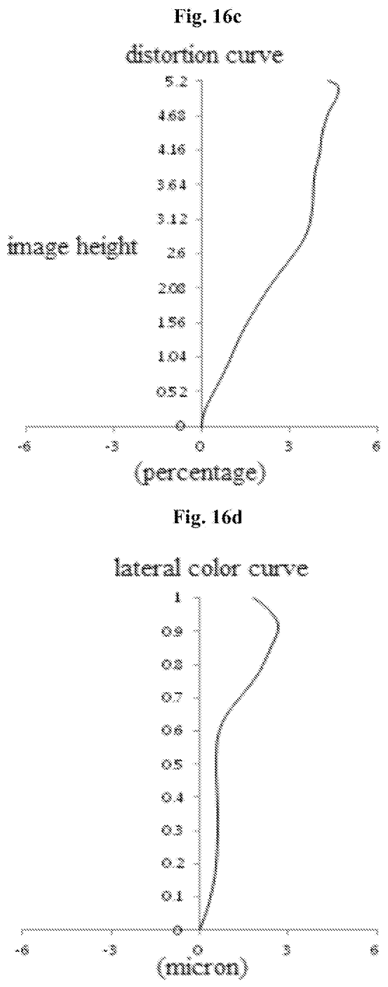

FIG. 16a shows a longitudinal aberration curve of the optical imaging lens assembly according to Embodiment 8 to represent deviations of a convergence focal point after light with different wavelengths passes through the lens assembly. FIG. 16b shows an astigmatism curve of the optical imaging lens assembly according to Embodiment 8 to represent a tangential image surface curvature and a sagittal image surface curvature. FIG. 16c shows a distortion curve of the optical imaging lens assembly according to Embodiment 8 to represent distortion values corresponding to different image heights. FIG. 16d shows a lateral color curve of the optical imaging lens assembly according to Embodiment 8 to represent deviations of different image heights on the imaging surface after the light passes through the lens assembly. According to FIGS. 16a-16d, it can be seen that the optical imaging lens assembly provided in Embodiment 8 may achieve high imaging quality.

The above is only the preferred embodiment of the disclosure and are not intended to limit the disclosure. Any modifications, improvements, equivalent replacements and the like made within the spirit and principle of the disclosure shall fall within the scope of protection of the disclosure.

What is claimed is:

1. An optical imaging lens assembly, sequentially comprising, from an object side to an image side along an optical axis:
a first lens with a positive refractive power;
a second lens with a refractive power;
a third lens with a refractive power;
a fourth lens with a positive refractive power;
a fifth lens with a refractive power, an object-side surface thereof being a convex surface while an image-side surface being a concave surface;
a sixth lens with a positive refractive power, an object-side surface thereof being a convex surface while an image-side surface being a convex surface; and
a seventh lens with a negative refractive power,
wherein ImgH is a half of a diagonal length of an effective pixel region on an imaging surface, TTL is an on-axis distance from an object-side surface of the first lens to the imaging surface, and ImgH and TTL satisfy: 4.0 mm<ImgH×ImgH/TTL<6.0 mm; and FOV is a maximum field of view of the optical imaging lens assembly, and an effective focal length f of the optical imaging lens assembly and FOV satisfy: 4.8 mm<f×tan(1/2FOV)<5.8 mm.

2. The optical imaging lens assembly according to claim 1, wherein TTL and ImgH satisfy: TTL/ImgH<1.3.

3. The optical imaging lens assembly according to claim 1, wherein EPD is an entrance pupil diameter of the optical imaging lens assembly, and the effective focal length f of the optical imaging lens assembly and EPD satisfy: f/EPD<1.7.

4. The optical imaging lens assembly according to claim 1, wherein a curvature radius R11 of the object-side surface of the sixth lens, a curvature radius R12 of the image-side surface of the sixth lens and an effective focal length f6 of the sixth lens satisfy: 2.0<(R11-R12)/f6<2.5.

5. The optical imaging lens assembly according to claim 1, wherein an effective focal length f1 of the first lens, an effective focal length f7 of the seventh lens and the effective focal length f of the optical imaging lens assembly satisfy: 1.4<(f1-f7)/f<1.8.

6. The optical imaging lens assembly according to claim 1, wherein an effective focal length f2 of the second lens, a curvature radius R4 of an image-side surface of the second lens and a curvature radius R3 of an object-side surface of the second lens satisfy: 1.9<f2/(R4-R3)<7.1.

7. The optical imaging lens assembly according to claim 1, wherein a center thickness CT1 of the first lens on the optical axis, a center thickness CT2 of the second lens on the optical axis, a center thickness CT3 of the third lens on the optical axis and a center thickness CT4 of the fourth lens on the optical axis satisfy: 1.4<(CT1+CT2)/(CT3+CT4)<2.2.

8. The optical imaging lens assembly according to claim 1, wherein a combined focal length f12 of the first lens and the second lens, a combined focal length f67 of the sixth lens and the seventh lens and a combined focal length f34 of the third lens and the fourth lens satisfy: −1.0<(f12-f67)/f34<1.0.

9. The optical imaging lens assembly according to claim 1, wherein SAG62 is an on-axis distance from an intersection point of the image-side surface of the sixth lens and the optical axis to an effective radius vertex of the image-side surface of the sixth lens, SAG52 is an on-axis distance from an intersection point of the image-side surface of the fifth lens and the optical axis to an effective radius vertex of the image-side surface of the fifth lens satisfy: 1.6<SAG62/SAG52<2.4.

10. The optical imaging lens assembly according to claim 1, wherein SAG71 is an on-axis distance from an intersection point of an object-side surface of the seventh lens and the optical axis to an effective radius vertex of the object-side surface of the seventh lens, and SAG71 and an edge thickness ET7 of the seventh lens satisfy: −3.6<SAG71/ET7<−1.3.

11. The optical imaging lens assembly according to claim 1, an edge thickness ET4 of the fourth lens, an edge thickness ET5 of the fifth lens and an edge thickness ET6 of the sixth lens satisfy: 0.7<(ET4+ET5)/ET6<1.4.

12. An optical imaging lens assembly, sequentially comprising, from an object side to an image side along an optical axis:
a first lens with a positive refractive power;
a second lens with a refractive power;
a third lens with a refractive power;
a fourth lens with a positive refractive power;
a fifth lens with a refractive power, an object-side surface thereof being a convex surface while an image-side surface being a concave surface;
a sixth lens with a positive refractive power, an object-side surface thereof being a convex surface while an image-side surface being a convex surface; and
a seventh lens with a negative refractive power,
wherein ImgH is a half of a diagonal length of an effective pixel region on an imaging surface, TTL is an on-axis distance from an object-side surface of the first lens to the imaging surface, and ImgH and TTL satisfy: 4.0 mm<ImgH×ImgH/TTL<6.0 mm; and EPD is an entrance pupil diameter of the optical imaging lens assembly, and an effective focal length f of the optical imaging lens assembly and EPD satisfy: f/EPD<1.7.
